(19) United States
(12) Patent Application Publication
(10) Pub. No.: US 2009/0019551 A1
(43) Pub. Date: Jan. 15, 2009

(54) INFORMATION SECURITY DEVICE AND COUNTER CONTROL METHOD

(76) Inventors: Tomoyuki HAGA, Nara (JP); Kenneth Alexander NICOLSON, Hyogo (JP); Hideki MATSUSHIMA, Osaka (JP); Takayuki ITO, Osaka (JP); Hisashi TAKAYAMA, Osaka (JP); Manabu MAEDA, Osaka (JP)

Correspondence Address: WENDEROTH, LIND & PONACK L.L.P., 2033 K. STREET, NW, SUITE 800, WASHINGTON, DC, 20006, US

(21) Appl. No.: 12/146,269

(22) Filed: Jun. 25, 2008

(30) Foreign Application Priority Data
Jun. 25, 2007 (JP) 2007-166321

(51) Int. Cl. H04L 9/32; H04L 9/08

(52) U.S. Cl. 726/27; 380/44

(57) ABSTRACT

A method is provided for flexibly setting a shared counter shared by a plurality of security modules sharing a counter in tree structures, while curbing the amount of secure memory used. The shared counter is realized by a first counter group having a tree structure managed by a first secure module and a second counter group having a tree structure managed by a second secure module sharing a node in the tree structure of the first counter group and a node in the tree structure of the second counter group. The method of sharing using tree structures enables flexibly addition, deletion and access restriction setting of modules that use the shared counter.

This application is based on application No. 2007-166321 filed in Japan, the content of which is hereby incorporated by reference.

### BACKGROUND OF THE INVENTION

(1) Field of the Invention

The present invention relates to a way for security modules to share a secure counter.

(2) Description of the Related Art

In recent years, demand for techniques to protect data is increasing, as consciousness regarding information security becomes high.

As a result of such circumstances, the Trusted Computing Group (TCG) was established with an object of developing and popularizing a secure computer platform. In the TCG, a security core module called a Trusted Platform Module (TPM) is used to realize a secure terminal environment. As shown in Non-Patent Document 1, one function of the TCG for realizing a secure terminal environment is the secure counter specification called a monotonic counter that is managed in the TPM. This counter is used to prevent a rollback attack that replaces a program, certificate or the like in a terminal with an old version of the program, the certificate or the like.

In this way, the way in which the monotonic counter is used in the TPM is limited. For this reason, Non-Patent Document 2 discloses a technique for realizing a virtual monotonic counter outside the TPM without increasing the number of secure counters in the TPM.

Patent Document 1 discloses a method for implementing a secure counter that uses a parent counter and a multiplicity of child counters.

With the technique of Non-Patent Document 1, the number of monotonic counters provided in the TPM is small and the way in which the monotonic counters are used is limited. There is also a problem that counters cannot be added or deleted. Furthermore, since the monotonic counters are managed within a TPM, there is a further problem that secure counters cannot be shared by a plurality of TPMs.

In order to resolve the problems of Non-Patent Document 1, the technique of Non-Patent Document 2 realizes a virtual monotonic counter outside the TPM without increasing the number of secure counters in the TPM. However, there is a problem that in a model in which a plurality of TPMs exist in a single terminal, the plurality of TPMs cannot share a virtual monolithic counter.

As with Non-Patent Document 2, Patent Document 1 discloses a method for one secure module to manage a parent counter and a plurality of child counters, but has the problem of a lack of a mechanism to enable shared use of a counter by a plurality of secure devices.

Non-Patent Document 1: TPM Main Part 1 Design Principles Specification Version 1.2 Revision 94

Non-Patent Document 2: “Virtual Monotonic Counters and Count-Limited Objects using a TPM without Trusted OS (Extended Version)”, Luis F. G. Sarmenta (2006)

Patent Document 1: Japanese Unexamined Patent Application Publication No. 2004-38968

### SUMMARY OF THE INVENTION

The present invention solves the conventional problems, and has an object of providing an information processing device that enables a counter to be shared by a plurality of secure modules and curbs the amount of secure memory used, and an information processing method which enables settings relating to a shared secure counter to be made flexibly.

In order to achieve the stated object, an information processing device in one aspect of the present invention includes: a program storage unit operable to store therein a first program and a second program; a counter storage unit operable to store therein a first counter group composed of one or more counters used by the first program, and a second counter group composed of one or more counters used by the second program, the first counter group and the second counter group sharing at least one shared counter used by both the first program and the second program; a counter verification unit operable to perform verification of integrity of the first counter group and verification of integrity of the second counter group; and a counter control unit operable to prohibit the first program from accessing the at least one shared counter when verification of the integrity of the first counter group fails, and prohibit the second program from accessing the at least one shared counter when verification of the integrity of the second counter group fails.

According to the stated structure, a counter can be provided that is in both the first counter group used by the first program and the second counter group used by the second program, and is usable by the first program and the second program.

### BRIEF DESCRIPTION OF THE DRAWINGS

These and other objects, advantages and features of the invention will become apparent from the following description thereof taken in conjunction with the accompanying drawings which illustrate a specific embodiment of the invention.

In the drawings:

FIG. 1 shows the overall structure of a terminal in a first embodiment of the present invention;

FIG. 2 shows a counter group 1 having a tree structure in the first embodiment of the present invention;

FIG. 3 shows a counter management table in the first embodiment of the present invention;

FIG. 4 is a flowchart showing a counter read procedure in the first embodiment of the present invention;

FIG. 5 is a flowchart showing a first part of counter increment processing in the first embodiment of the present invention;

FIG. 6 is a flowchart showing a second part the counter increment processing in the first embodiment of the present invention;

FIG. 7 is a flowchart showing a shared counter creation procedure in the first embodiment of the present invention;

FIG. 8 shows counters shared by a counter group 1 and a counter group 2 in the first embodiment of the present invention;

FIGS. 9A and 9B show shared counter management tables in the first embodiment of the present invention;

FIG. 10 shows shared counters in a counter group 1, a counter group 2 and a counter group 3 in the first embodiment of the present invention;

FIGS. 11A, 11B and 11C show shared counter management tables of secure modules 1, 2 and 3 in the first embodiment of the present invention;

FIG. 12 shows a shared data usage service system in a multi stakeholder model in the first embodiment of the present invention;

FIG. 13 is a flowchart showing a time variable key preparation procedure in the first embodiment of the present invention;

FIG. 14 is a flowchart showing a procedure for shared data encryption and decryption using the time variable key in the first embodiment of the present invention;

FIG. 15 is a flowchart showing a procedure for shared data encryption and decryption using the time variable key in the first embodiment of the present invention;

FIG. 16 is an updating system for updating a stakeholder application in a terminal 1600 in the second embodiment of the present invention;

FIG. 17 shows the overall structure of a terminal in a second embodiment of the present invention;

FIG. 18 is a flowchart showing shared counter access permission setting in the second embodiment of the present invention;

FIGS. 19A and 19B show shared counter management tables in the second embodiment of the present invention; and

FIG. 20 is a flowchart showing a procedure for updating a stakeholder environment in the terminal in the second embodiment of the present invention.

### NUMERICAL REFERENCES

10 Information security device
20, 1720 CPU
30, 1730 RAM
40, 1740 Program storage unit
41, 1010, 1741 App1
42, 1020, 1742 App2
1030 App3
50, 1011, 1212, 1750 Secure module 1
60, 1021, 1222, 1760 Secure module 2
1031 Secure module 3
51, 61, 1751, 1761 Verification unit
52, 62, 1752, 1762 Measuring unit
53, 63, 1753, 1763 Counter control unit
54, 64, 1754, 1764 Encryption unit
55, 65, 1755, 1765 Secure memory
56, 66, 1756, 1766 Shared data access unit
70, 1770 Counter storage unit
71, 1771 Counter group 1
72, 1772 Counter group 2
80, 1230, 1780 Shared data storage unit
90, 1790 Bus
200 Authentication hash value
300 Counter management table
301 Tree root address
302 Tree structure information
303 Number of counters
304, 305 Counter value address management table
306 Counter ID
307 Counter address
800 Shared counter group
900, 910, 1110, 1120, 1130, 1910, 1920 Shared counter management table
901, 911, 1111, 1121, 1131, 1191, 1921 Node ID
902, 912, 1112, 1122, 1132, 1912, 1922 Node address
903, 913, 1113, 1123, 1133, 1913, 1923 Application ID
1200, 1600 Terminal
1210, 1220 Stakeholder environment
1211 Service 1 application
1221 Service 2 application
1231 Value
1240 Service 1 providing server
1250 Service 2 providing server
1260, 1603 Network
1601 Updating server
1602 Updating program
1790 Updating unit
1781 Communication I/F
1914, 1924 Access permission information

### DESCRIPTION OF THE PREFERRED EMBODIMENT

An information processing device that is an aspect recited in claim 1 includes: a program storage unit operable to store therein a first program and a second program; a counter storage unit operable to store therein a first counter group composed of one or more counters used by the first program, and a second counter group composed of one or more counters used by the second program, the first counter group and the second counter group sharing at least one shared counter used by both the first program and the second program; a counter verification unit operable to perform verification of integrity of the first counter group and verification of integrity of the second counter group; and a counter control unit operable to prohibit the first program from accessing the at least one shared counter when verification of the integrity of the first counter group fails, and prohibit the second program from accessing the at least one shared counter when verification of the integrity of the second counter group fails.

Here, an information processing device that is an aspect recited in claim 2 may further include: a storing unit operable to store therein access permission information showing whether or not the first program is permitted to access the at least one shared counter and whether or not the second program is permitted to access the at least one shared counter; a program verification unit operable to verify integrity of the first program and verify integrity of the second program; and an access management unit operable to, when the verification of at least one of the integrity of the first program and the integrity of the second program fails, update the access permission information such that the access permission information shows that the at least one of the first program and the second program for which the verification of integrity failed is prohibited from accessing the at least one shared counter, wherein the counter control unit is further operable to prevent, from accessing the at least one shared counter, the at least one of the first program and the second program shown as being prohibited from accessing the at least one shared counter in the access permission information.

According to the stated structure, when a program that can use the shared counter has been tampered with, the program that has been tampered with can be restricted from accessing the shared counter.

Here, an information processing device that is an aspect recited in claim 3 may include: a first secure module that is tamper resistant; and a second secure module that is tamper resistant, wherein the counter verification unit includes: a first counter verification unit operable to perform the verification of the integrity of the first counter group; and a second counter verification unit operable to perform the verification of the integrity of the second counter group, wherein the first counter verification unit is included inside the first secure module, and the second counter verification unit is included inside the second secure module.

According to the stated structure, since the units relating to counter operations are tamper resistant, the counters can be implemented more securely.

Here, an information processing device that is an aspect recited in claim 4 may control the first counter group with use of a first tree structure and control the second counter group with use of a second tree structure, wherein the counters in the first counter group are assigned in one-to-one correspondence to leaves in the first tree structure, and the counters in the second counter group are assigned in one-to-one correspondence to leaves in the second tree structure, the first counter verification unit includes: a verification value calculation sub-unit operable to calculate a first root verification value that is a verification value allocated to the root of the first tree structure, by performing the following procedure repeatedly in a direction from the leaves toward the root with respect to each node in the first tree structure other than the leaves: (a) calculating a verification value from a value of one child node of said node, and (b) allocating the calculated verification value to said node; a secure memory operable to pre-store therein a first root authentication value equal to the first root verification value obtained when the first counter group has not been tampered with; and a judgment sub-unit operable to judge that the verification of the integrity of the first counter group has failed when the first root verification value and the first root authentication value are not equal, the second counter verification unit includes: a verification value calculation sub-unit operable to calculate a second root verification value that is a verification value allocated to the root of the second tree structure, by performing the following procedure repeatedly in a direction from the leaves toward the root with respect to each node in the second tree structure other than the leaves: (a) calculating a verification value from a value of one child node of said node, and (b) allocating the calculated verification value to said node; a secure memory operable to pre-store therein a second root authentication value equal to the second root verification value obtained when the second counter group has not been tampered with; and a judgment sub-unit operable to judge that the verification of the integrity of the second counter group has failed when the second root verification value and the second root authentication value are not equal.

According to the stated structure, by merely sharing intermediate nodes in the tree structure, settings such as adding, canceling and revoking counters can be performed flexibly.

Here, an information processing device that is an aspect recited in claim 5 may further include a shared data storage unit operable to store therein shared data that is information shared by the first program and the second program, wherein the first secure module further includes: a key generation sub-unit operable to generate an encryption key with use of a value of the at least one shared counter; an encryption sub-unit operable to encrypt, with use of the encryption key, the shared data received from the first program; and a write sub-unit operable to store the shared data, which is in an encrypted state, to the shared data storage unit, and wherein the second secure module further includes: a reading sub-unit operable to read the shared data from the shared data storage unit; a key generation sub-unit operable to generate a decryption key with use the value of the at least one shared counter; a decryption sub-unit operable to decrypt the shared data which is in the encrypted state, with use of the decryption key; and a providing sub-unit operable to provide the shared data obtained as a result of the decryption to the second program.

According to the stated structure, shared data can be managed more securely.

Here, in the information processing device that is an aspect recited in claim 6, the first secure module, when the first program is prohibited from accessing the shared counter, may prohibited from generating the encryption key using the value of the at least one shared counter, and the second secure module, when the second program is prohibited from accessing the shared counter, may be prohibited from generating the decryption key using the value of the at least one shared counter.

Here, an information processing device that is an aspect recited in claim 7 may further include: a shared data storage unit operable to store therein shared data that is information shared by the first program and the second program, wherein the first program stores the shared data to the shared data storage unit via the first secure module, the second program reads the shared data from the shared data storage unit via the second secure module, the first secure module controls the first counter group with use of a first tree structure, the counters in the first counter group being assigned in one-to-one correspondence to leaves in the first tree structure, the first counter verification unit includes: a verification value calculation sub-unit operable to calculate a first root verification value that is a verification value allocated to the root of the first tree structure, by performing the following procedure repeatedly in a direction from the leaves toward the root with respect to each node in the first tree structure other than the leaves: (a) calculating a verification value from a value of one child node of said node, and (b) allocating the calculated verification value to said node; a secure memory operable to pre-store therein a first root authentication value equal to the first root verification value obtained when the first counter group has not been tampered with; and a judgment sub-unit operable to judge that the verification of the integrity of the first counter group has failed when the first root verification value and the first root authentication value are not equal, wherein the first secure module further includes: a key generation sub-unit operable to, when the verification of the first counter group is successful, generate an encryption key with use of a value of the at least one shared counter; an encryption sub-unit operable to encrypt, with use of the encryption key, shared data received from the first program; and a write sub-unit operable to write the shared data, which is in an encrypted state, to the shared data storage unit, wherein the second secure module controls the second counter group with use of a second tree structure, and the counters in the second counter group are assigned in one-to-one correspondence to leaves in the second tree structure, the second counter verification unit includes: a verification value calculation sub-unit operable to calculate a second root verification value that is a verification value allocated to the root of the second tree structure, by performing the following procedure repeatedly in a direction from the leaves toward the root with respect to each node in the second tree structure other than the leaves: (a) calculating a verification value from a value of one child node of said node, and (b) allocating the calculated verification value to said node; a secure memory operable to pre-store therein a second root authentication value equal to the second root verification value obtained when the second counter group has not been tampered with; and a judgment sub-unit operable to judge that the verification of the integrity of the second counter group has failed when the second root verification value and the second root authentication value are not equal, and wherein the second secure module further includes: a key generation sub-unit operable to, when the verification of the integrity of the second counter group is successful, generate a decryption key with use the value of the at least one shared counter; a decryption sub-unit operable to decrypt the shared data which is in the encrypted state, with use of the decryption key; and a providing sub-unit operable to provide the shared data obtained as a result of the decryption to the second program.

Here, an information processing device that is an aspect recited in claim 8 may further include a program updating unit operable to, when the access permission information shows that at least one of the first program and the second program is prohibited from accessing the shared counter, update the at least one program shown as being prohibited from accessing the shared counter, wherein the program verification unit is further operable to verify integrity of the at least one updated program, and the access management unit, when the verification of the at least one updated program succeeds, updates the access permission information such that the access permission information shows that the at least one updated program is permitted to access the at least one shared counter.

According to the stated structure, when a program that can use the shared counter has been tampered with, the program that has been tampered with can be restricted from accessing the shared counter.

Here, in an information processing device that is an aspect recited in claim 9, the first module and/or the second module may be realized by a TPM specified by Trusted Computing Group (TCG).

According to the stated structure, the information processing device of the present invention is capable of constructing a secure execution environment, and counter control can be executed more securely.

Here, in an information processing device that is an aspect recited in claim 10, the first module and/or the second module may be realized by an MTM specified by Trusted Computing Group (TCG).

According to the stated structure, According to the stated structure, the information security device of the present invention can be implemented in a mobile phone. Furthermore, counters can be shared by multi stakeholders, which are a feature of MTM. Furthermore, the stated structure prevents a backup restore attack against shared data used by multi stake holders using a shared counter.

Furthermore, an information processing method that is an aspect recited in claim 11 is an information processing method used in an information processing device, the information processing device including: a program storage unit operable to store therein a first program and a second program; and a counter storage unit operable to store therein a first counter group composed of one or more counters used by the first program, and a second counter group composed of one or more counters used by the second program, the first counter group and the second counter group sharing at least one shared counter used by both the first program and the second program, the information processing method including the steps of: performing verification of integrity of the first counter group and verification of integrity of the second counter group; and prohibiting the first program from accessing the at least one shared counter when verification of the integrity of the first counter group fails, and prohibiting the second program from accessing the at least one shared counter when verification of the integrity of the second counter group fails.

Furthermore, a recording medium that is an aspect recited in claim 12 is a recording medium on which is recorded an information processing program used in an information processing device, the information processing device including: a program storage unit operable to store therein a first program and a second program; and a counter storage unit operable to store therein a first counter group composed of one or more counters used by the first program, and a second counter group composed of one or more counters used by the second program, the first counter group and the second counter group sharing at least one shared counter used by both the first program and the second program, the information processing program causing the information processing device to perform the steps of: performing verification of integrity of the first counter group and verification of integrity of the second counter group; and prohibiting the first program from accessing the at least one shared counter when verification of the integrity of the first counter group fails, and prohibiting the second program from accessing the at least one shared counter when verification of the integrity of the second counter group fails.

Furthermore, an integrated circuit that is an aspect recited in claim 13 is an integrated circuit used in an information processing device, the integrated circuit including: a program storage unit operable to store therein a first program and a second program; a counter storage unit operable to store therein a first counter group composed of one or more counters used by the first program, and a second counter group composed of one or more counters used by the second program, the first counter group and the second counter group sharing at least one shared counter used by both the first program and the second program; a counter verification unit operable to perform verification of integrity of the first counter group and verification of integrity of the second counter group; and a counter control unit operable to prohibit the first program from accessing the at least one shared counter when verification of the integrity of the first counter group fails, and prohibit the second program from accessing the at least one shared counter when verification of the integrity of the second counter group fails.

Furthermore, an information processing device that is an aspect recited in claim 14 includes: a program storage unit operable to store therein a first program and a second program; a counter storage unit operable to store therein a first counter group composed of one or more counters used by the first program, and a second counter group composed of one or more counters used by the second program, the first counter group and the second counter group sharing at least one shared counter used by both the first program and the second program; a storing unit operable to store therein access permission information showing whether or not the first program is permitted to access the at least one shared counter and whether or not the second program is permitted to access the at least one shared counter; a program verification unit operable to verify integrity of the first program and verify integrity of the second program; an access management unit operable to, when the verification of at least one of the integrity of the first program and the integrity of the second program fails, update the access permission information such that the access permission information shows that the at least one of the first program and the second program for which the verification of integrity failed is prohibited from accessing the at least one shared counter; and a counter control unit operable to prevent, from accessing the at least one shared counter, the at least one of the first program and the second program shown as being prohibited from accessing the at least one shared counter in the access permission information.

The following describes embodiments of the present invention with reference to the drawings.

### First Embodiment

The following describes a preferred embodiment of the present invention.

<Terminal Structure>

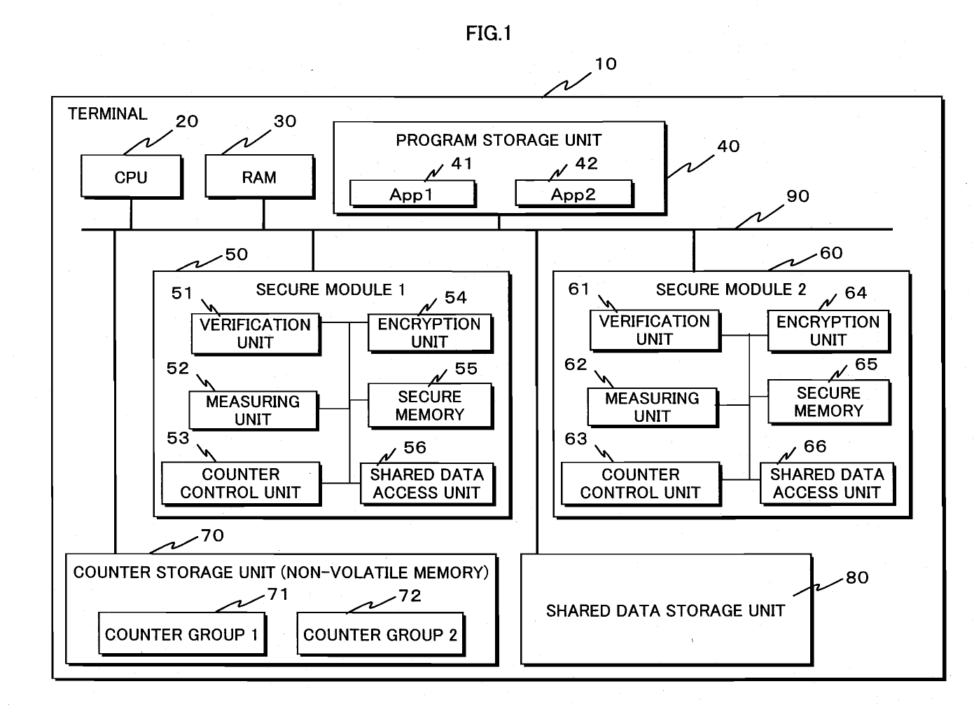

FIG. 1 shows the overall structure of a terminal 10 in the present embodiment.

In the first embodiment, a description is given of an information security device that accesses shared data to perform desired processing, and performs the desired processing by two applications App1 (41) and App2 (42) using respective counter groups (71, 72) managed by respective counter control units (53, 63) in respective secure modules 50 and 60.

As shown in FIG. 1, the information security device 10 is composed of a CPU 20, a RAM 30, a program storage unit 40, a secure module 1 (50), a secure module 2 (60), a counter storage unit 70, and a shared data storage unit 80. The stated components are connected to each other via a bus 90.

The CPU 20 realizes various function units described below, by executing a program stored in the program storage unit 40, and programs stored in the RAM 30, the secure module 1 (50), and the secure module (60).

The RAM 30 is a volatile storage medium that stores a program that it has loaded from the program storage unit 40. The RAM 30 also stores temporary data, acting as a work memory for programs executed by the CPU 20.

The program storage unit 40 is a non-volatile recording medium that data can be written to and erased from. As one example, the program storage unit 40 is a hard disk or a flash memory. In the present embodiment, the program storage unit 40 stores application App1 (41) and application App2 (42).

The secure module 1 (50) is a module implemented in a tamper-resistant manner, and is used by application App1 (41). The secure module 1 (50) is composed of a verification unit 51, a measuring unit 52, a counter control unit 53, an encryption unit 54, a secure memory 55, and a shared data access unit 56.

The secure memory 55 in the secure module 1 (50) is a non-volatile recording medium that data can be written to and erased from. The secure memory 55 stores an authentication hash value of a counter group 1. The authentication hash value is a hash value used to verify the integrity of the counter group 1. The method used to generate the authentication hash value is described later, and therefore a description thereof is omitted here.

The measuring unit 52 in the secure module 1 (50) calculates a hash value used to verify the integrity of the counter group 1 (71), namely using an SHA (Secure Hash Algorithm) 1 algorithm.

The verification unit 51 in the secure module 1 (50) compares the hash value of the counter group 1 (71) calculated by the measuring unit 52 and the authenticated hash value of the counter group 1 (71), and notifies the counter control unit 53 of the result of the comparison.

The counter control unit 53 in the secure module 1 (50) controls read processing and increment processing of the counter group 1 (71) in accordance with the result from the verification unit 51, and stores information necessary for the read processing and the increment processing in counter management information. Note that read processing refers to processing for reading the value of a counter, and increment processing refers to increasing the value of a counter.

The encryption unit 54 performs data encryption and decryption processing. Specific examples of encryption and decryption processing methods are AES (Advanced Encryption Standard) encryption that is a symmetric encryption scheme, RSA encryption that is an asymmetric key encryption scheme, and an elliptic curve cryptosystem.

The shared data access unit 56 is used when App1 (41) accesses shared data. The shared data access unit 56 performs read and write processing with respect to the shared data storage unit 80, and encryption and decryption processing of shared data using the encryption unit 54.

The secure module 2 (60) is a module implemented in a tamper-resistant manner, and is used by application App2 (42). The secure module 2 (60) is composed of a verification unit 61, a measuring unit 62, a counter control unit 63, an encryption unit 64, a secure memory 65, and a shared data access unit 66.

The secure memory 65 in the secure module 2 (60) is a non-volatile recording medium that data can be written to and erased from. The secure memory 65 stores an authentication hash value of a counter group 2. Here, the authentication hash value is a hash value used to verify the integrity of the counter group 2. The method used to generate the authentication hash value is described later, and therefore a description thereof is omitted here.

The measuring unit 62 in the secure module 2 (60) calculates a hash value used to verify the integrity of the counter group 2 (72), namely using an SHA 1 algorithm.

The verification unit 61 in the secure module 1 (60) compares the hash value of the counter group 2 (72) calculated by the measuring unit 62 and the authenticated hash value of the counter group 2 (72), and notifies the counter control unit 63 of the result of the comparison.

The counter control unit 63 in the secure module 1 (60) controls read processing and increment processing of the counter group 2 (72) in accordance with the result from the verification unit 61, and stores control information necessary for the processing in counter management information that functions as a counter management table and a shared counter management table. The counter management table and the shared management table are described later.

The encryption unit 64 performs data encryption and decryption processing. Specific examples of encryption and decryption processing methods are AES encryption that is a symmetric encryption scheme, RSA encryption that is an asymmetric key encryption scheme, and an elliptic curve cryptosystem.

The shared data access unit 66 is used by App2 (42) when accessing shared data. The shared data access unit 66 performs read and write processing with respect to the shared data storage unit 80, and encryption and decryption processing of the shared data using the encryption unit 64.

Note that the secure module 1 (50) and the secure module 2 (60) may be realized using a Trusted Platform Module (TPM). On the other hand, the TCG Mobile Phone WG defines an equivalent security module as a Mobile Trusted Module (MTM). The secure module 1 (50), the secure module 2 (60) and the like may be implemented as MTMs. Furthermore, although TPMs and MTMs are generally implemented using semiconductors, the TPMs and MTMs may be realized by software, or may be implemented using a combination of hardware and software.

Furthermore, although the measuring units (52, 62) are described as using SHA 1 in hash value calculation, the measuring units are not limited to using SHA 1, and may use SHA 256 or Keyed-Hashing for Message Authentication Code (HMAC-SHA1), for instance.

Note that the encryption units (54, 64) are not limited to using AES encryption, RSA encryption or an elliptic curve cryptosystem, and may use any encryption scheme generally used as a symmetric encryption scheme or an asymmetric key encryption scheme.

Note also that although the secure memories (55, 65) are described as being inside the secure modules, the secure memories may be located outside the secure modules. Since the secure memories will be outside the secure modules in this case, it will be necessary to make the secure memories tamper resistant.

The counter storage unit 70 is a non-volatile recording medium that data can be written to. The counter storage unit 70 stores the counter group 1 (71) used by App1 (41) via the secure module 1 (50), and the counter group 2 (72) used by App2 via the secure module 2 (60). Note that when the counter group 1 (71) and the counter group 2 (72) are used by the secure module 1 (50) and the secure module 2 (50), respectively, the counter group 1 (71) and the counter group 2 (72) may be loaded into the RAM (30) and used from the RAM (30). In this case, any updates to the counter group 1 (71) and the counter group 2 (72) due to counter increment processing or the like are reflected in the counter storage unit 70.

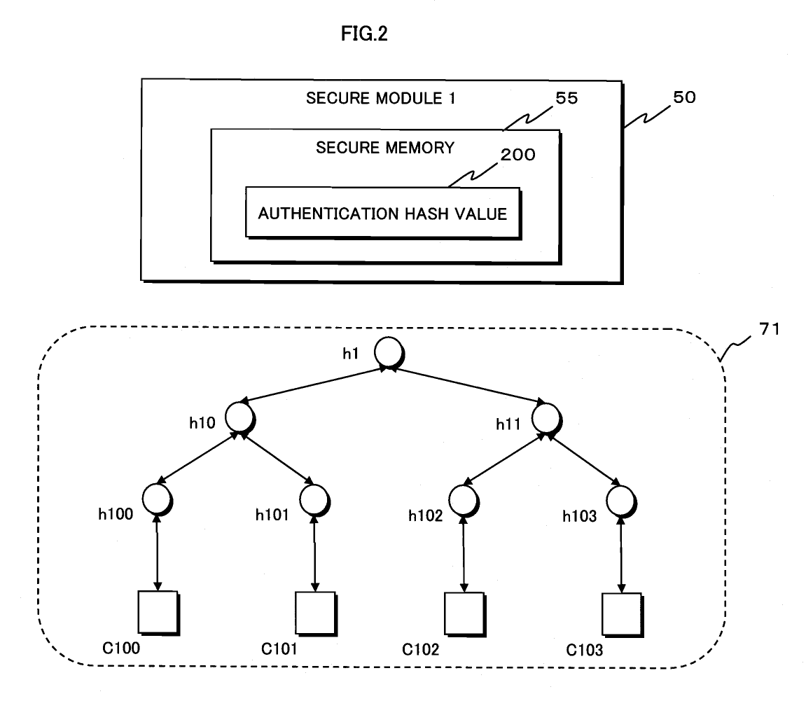

Each of the counter group 1 (71) and the counter group 2 (72) is composed of one or more counters, and hash values calculated from the one of more counters. Each of the counter group 1 (71) and the counter group 2 (72) is managed according to a tree structure. The management according to the tree structure is described later with use of FIG. 2.

The shared data storage unit 80 stores shared data used by both App1 (41) and App2 (42). The shared data storage unit 80 is accessed by App2 (42) via the shared data access unit 56 of the secure module 1 (50), and by App2 (42) via the shared data access unit 66 of the secure module 2 (60). In the first embodiment, the shared data is information that has a value (herein after such information is referred to as a value) and should be processed securely (secure data), examples being electronic money and rights information in DRM (Digital Rights Managements). The first embodiment realizes a desired application service by App1 (41) and App2 (42) both using the value. Generally when managing such shared data, it is necessary to prevent a backup restore attack. A backup restore attack is an attack that backs up secure data, restores (re-writes) the backed-up data to the memory of a terminal, and using the old value, receives a service maliciously. In view of the need to prevent such an attack, shared data is managed by being encrypted using a time variable key in the present embodiment. The time variable key is a key whose value changes with a certain timing each time a certain amount of time passes. The time variable key is described later.

<Counter Group Tree Structure>

FIG. 2 shows the tree structure of the counter group 1 (71) used by App1 (41) via the secure module 1 (50).

Here, a root node is a node that does not have a parent node and is located at the top of the tree structure. An intermediate node is a node that has a parent node and one or more child nodes. A leaf node is a node that has a parent node only.

As shown in FIG. 2, in the present example, the counter group 1 (71) has four counters (C100, C101, C102, C103), which are managed as leaf nodes in the tree structure. Furthermore, in the tree structure, an intermediate node h100 stores the hash value of the counter C100, an intermediate node h101 stores the hash value of the counter C101, an intermediate node h102 stores the hash value C102, and an intermediate node h103 stores the hash value C103. An intermediate node h10 stores a hash value of a concatenated value of h100 and h101, and an intermediate node h11 stores a hash value of a concatenated value of h102 and h103. A root node h1 stores a hash value of a concatenated value of h10 and h11. The leaf nodes, the intermediate nodes and the root nodes are realized by a doubly linked list.

The secure memory 55 of the secure module 1 (50) stores an authentication hash value 200. In the present embodiment, the authentication hash value 200 is a value used for checking the integrity of a secure counter group, and is stored in the root node of the tree structure. The counter group 1 is stored outside the secure memory 55, and in order to use the counter group 1 (71), a hash value for storing in intermediate nodes is generated in a direction from the leaf nodes to the root node in the tree structure, and the hash value corresponding to the root node and the authentication hash value in the secure memory 55 are compared. The counter group 1 (71) can only be used when the result of the comparison is that the compared hash values are equal. In this way, by managing only the hash value corresponding to the root node in the secure memory 55 instead of managing the counter group 1 (71) in the secure memory 55, it is possible to effectively detect tampering with the counter group 1 (71), which is outside the secure memory 55. Furthermore, since it is not necessary to manage the entire counter group 1 (71) in the secure memory 55, the size of the secure memory can be kept to a minimum.

Although not illustrated in FIG. 2, the counter group 2 (72) is managed with the same kind of tree structure.

Note that the counter group is not limited to having a binary tree structure as in the present embodiment, and may have a different tree structure.

Furthermore, the counter group is not limited to being realized using a tree structure as in the present embodiment. For instance, an array having only the counter values may be used.

<Counter Management Table>

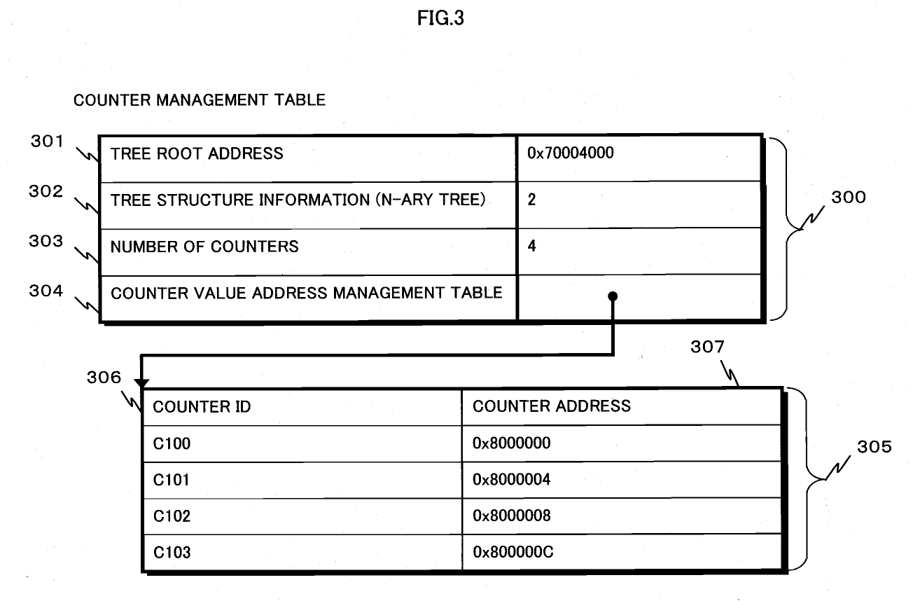

FIG. 3 shows a counter management table 300 stored by the counter control unit 53 in the secure module 1 (50), for controlling read processing and increment processing of the counter group 1 (71). The counter management table 300 is composed of a tree root address 301, tree structure information (N-ary tree) 302, a number of counters 303, and a counter value address management table 304. The counter address management table 306 is composed of counter IDs 306 and counter addresses 307. FIG. 3 is an example of the counter management table for the counter group 1 (71) shown in FIG. 2. The tree root address 301 is “0x70004000”. The tree structure information (N-ary) 302 is “2”, showing a binary tree. The number of counters 303 is “4”. The counter IDs 306 show that “C100” is stored at an address “0x80000000”, “C101” is stored at an address “0x80000004”, “C102” is stored at an address “0x80000008”, and “C103” is stored at an address “0x8000000C”. The read processing and increment processing of the counter group 1 (71) can be realized by referring to the counter management table 305.

<Counter Read Processing>

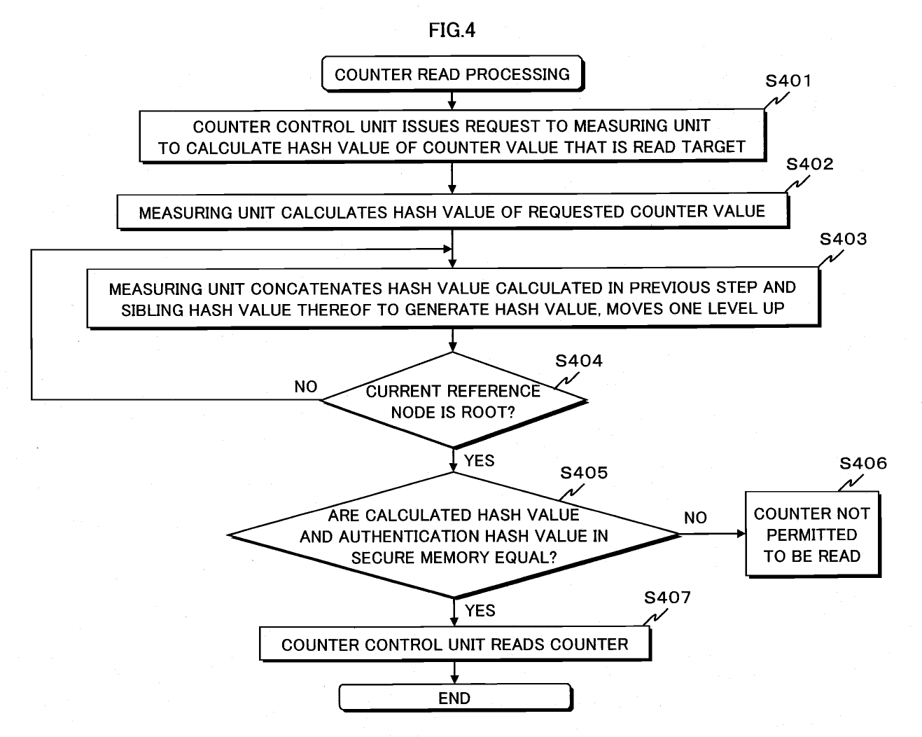

Referring to FIG. 4, a description is now given of counter read processing of the counter group 1 (71) by App1 (41) referring to the counter management table (300, 306). FIG. 4 shows the steps of the counter read processing.

First, App1 (41) issues a counter read request to the counter control unit 53 of the secure module 1 (50). Having received the counter read request, the counter control unit 53 makes a request to the measuring unit 52 to calculate a hash value of the value of the counter that is the target of reading (step S401). More specifically, in issuing the counter read request to the counter control unit 53, App1 (41) designates the counter ID of the counter that is the target of reading.

Next, the measuring unit 52 of the secure module 1 (50) refers to the counter management table 300, and calculates a hash value of the requested counter value (step S402).

Next, the measuring unit 52 generates a hash value of a concatenation of the hash value calculated in the previous step and the value of a sibling node, and utilizing the fact that nodes in the tree structure are a doubly linked list, moves the target of reference to a node one level higher in the tree (step S403).

The measuring unit 52 then refers to the tree root address 301 in the counter address management table 300, and judges whether the node that is currently the target of reference (herein after referred to as a reference node) is the root node or not (step S404). When the result of the judgment at step S404 is “YES” (i.e., when the current reference node is the root), the processing moves to step S405. On the other hand, when the result of the judgment at step S404 is NO (i.e. when the current reference node is not the root), the processing moves to step S403.

The verification unit 51 compares the calculated hash value calculated at step S403 with the authentication hash value 200 in the secure memory, to determine whether the two hash values are equal or not (step S405).

When the result of the comparison at step S403 is “YES” (i.e., when the calculated hash value and the authentication hash value are equal), the counter control unit reads the counter (step S407).

On the other hand, when the result of the comparison at step S403 is “NO” (i.e., when the calculated hash value and the authentication hash value are not equal), the requested counter is not permitted to be read (step S406).

<Counter Increment Processing>

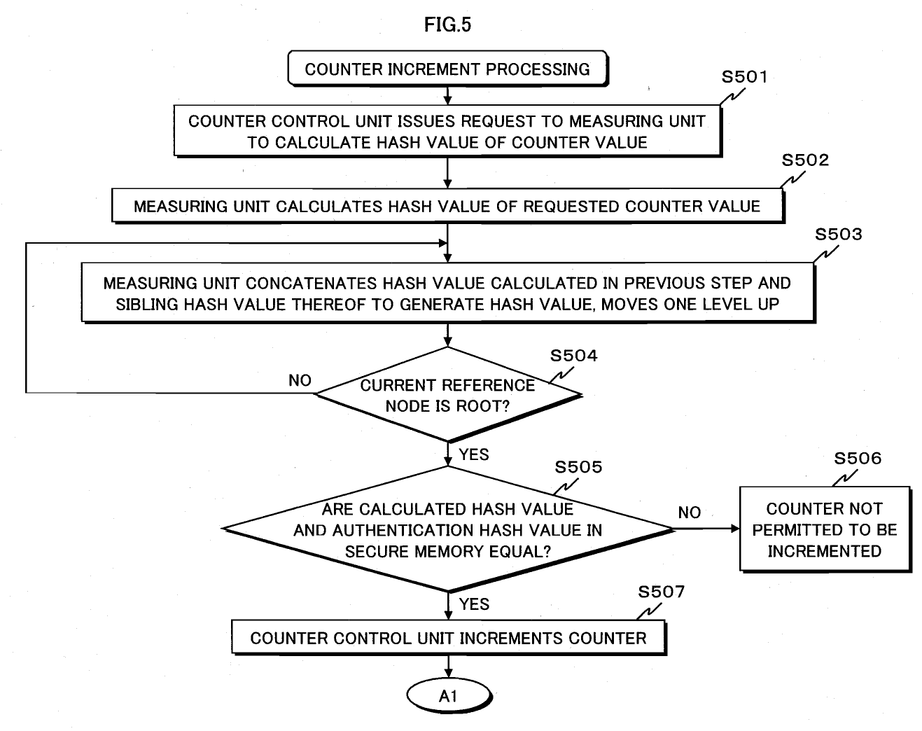

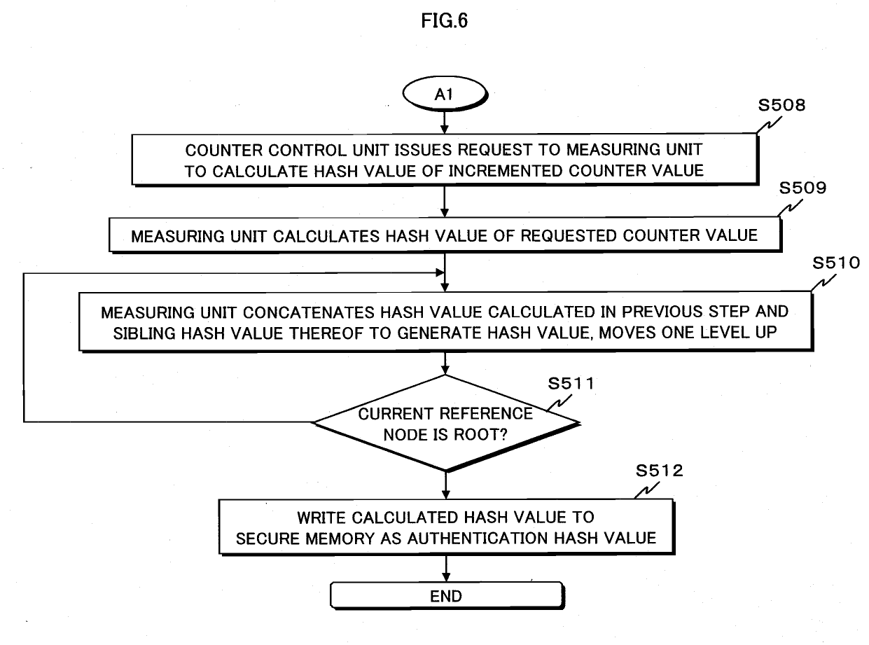

Referring to FIG. 5 and FIG. 6, a description is now given of increment processing of the counter group 1 (71) by App1 (41) referring to the counter management table 300. The processing of step S501 to step S505 of FIG. 5 is basically the same as the processing of step S401 to step S405 of FIG. 4, and therefore a description thereof is omitted. The stated steps in FIG. 5 differ from the stated steps in FIG. 4 only in that in FIG. 5 the result of the judgment at step S505 affects the decision of whether incrementing the counter is permitted or not permitted, whereas in FIG. 4 the result affects the decision of whether the decision of whether reading of the counter is permitted or not permitted. When incrementing is permitted, the counter is incremented at step S507.

When the counter is incremented, this means that the value of the leaf node in the tree structure is updated, and therefore the hash value stored in the root node must be re-calculated and the authentication hash value stored in the secure memory 55 must also be updated. Processing for updating the authentication hash value when a counter value is updated is shown in FIG. 6.

First, the counter control unit 53 issues a request to the measuring unit 52 to calculate a hash value of the value of the counter incremented at step S507 of FIG. 5 (S508).

Next, the measuring unit 52 of the secure module 1 (50) refers to the counter management table 300, and calculates a hash value of the requested counter value (step S509).

Next, the measuring unit 52 generates a hash value of a concatenation of the hash value calculated in the previous step and the value of a sibling node, and utilizing the fact that nodes in the tree structure are a doubly linked list, moves the target of reference to a node one level higher in the tree (step S510).

The measuring unit 52 then refers to the tree root address 301 in the counter address management table 300, and judges whether the current reference node is the root node or not (step S511). When the result of the judgment at step S511 is “YES” (i.e., when the current reference node is the root), the processing moves to step S512. On the other hand, when the result of the judgment at step S511 is “NO” (i.e. when the current reference node is not the root), the processing moves to step S510.

Next, the counter control unit 53 writes the hash value that is the value of the root node calculated by the measuring unit 52 to the secure memory 55 as the authentication hash value 200 (step S512).

<Creating a Shared Counter>

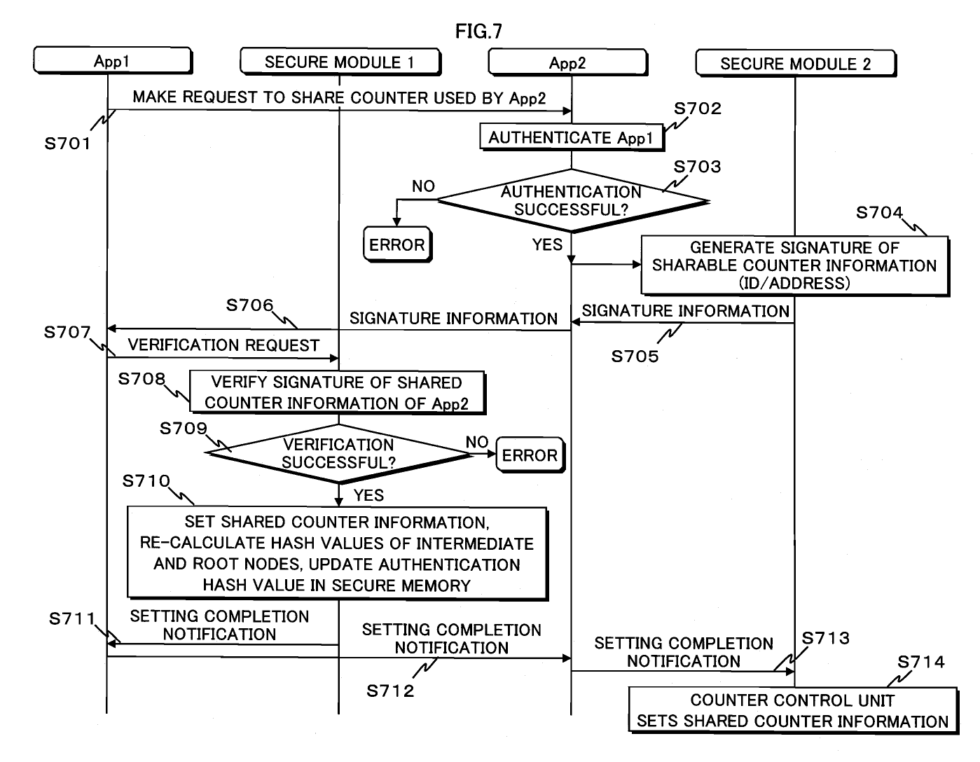

FIG. 7 is a flowchart of App1 (41) and App2 (42) sharing a counter between the counter group 1 (71) used by App1 (41) and managed in the secure module 1 (50), and the counter group 2 (72) used by App2 (42) and managed in the secure module 2 (60).

First, App1 (41) makes a request to App2 (42) to share a counter managed by the secure module 2 (60) (step S701).

App2 (42) authenticates App1 (41) (step S702). The authentication method used here is a method whereby each App is pre-associated with a certificate certifying that the App is legitimate, and App2 (42) verifies the certificate of App1 (41). Since the method used here is the method defined by PKI (Public Key Infra structure), a description thereof is omitted here. Note that the method used by applications to authenticate each other is not limited to the described method.

An other authentication method that may be used is a method whereby the measuring unit 52 and the verification unit 51 of the secure module 1 (50) are used to check whether of App1 (41) has been tampered with, and App2 (42) receives the result of the tampering check. In this case, the result of the tampering check may be sent after being encrypted by the encryption unit 54. Although not illustrated, the key used in this encryption may, for instance, be the public key of App2 (42) or the public key of the secure module 2. Furthermore, a secure communication path may be established between App1 (41) and App2 (42) using a SAC (Secure Authentication Channel), and a session key for use in encryption and decryption of data transmitted over the communication path may be shared and used.

When, as a result of the verification at step S703, App1 (41) is judged to be legitimate, the processing moves to step S704.

On the other hand, when App1 (41) is judged to not be legitimate as a result of the verification at step S703, an error result is returned to App2 (42), and the counter sharing processing ends.

When App1 (41) is judged to be legitimate, the counter control unit 63 of the secure module 2 (60) selects one of the counters in the counter group 2 (72) as a counter to share with App1 (41), and signs information of the selected counter (counter ID/counter address) (step S704). More specifically, the secure module 2 (60) has a private key of an RSA key pair generated for the secure module 2 (60), and uses the encryption unit 64 to generate an RSA signature. Note that the signing method is not limited to the described method, and any other digital signature method may be used.

Next, the signed shared counter information is transmitted from App2 (42) to App1 (41) (steps S705 and S706).

App1 (41) makes a request to the secure module 1 (50) to verify the signed shared counter information (step S707).

The counter control unit 53 of the secure module 1 (50) verifies the signature with use of the encryption unit 54 (step S708). More specifically, the secure module 1 (50) has a public key of an RSA key pair generated for the secure module 2 (60), and uses the encryption unit 64 to generate an RSA signature. Note that the signing method is not limited to the described method, and any other digital signature method may be used.

When, as a result of the signature verification at step S708, the signature is judged to be correct, the processing moves to step S710. On the other hand, when the signature is judged to be illegitimate, an error result is returned to App1 (41), and the counter sharing processing ends.

When the signature is judged to be correct, the counter control unit 53 of the secure module 1 (50) sets shared counter information in the counter management table 300 managed by the counter control unit 53. As a result, the shared counter in the tree structure composing the counter group 1 (71) is added to the tree structure as a node. Since the shared counter is added as a node, the hash values of the intermediate nodes and the root nodes in the tree structure of the counter group 1 must be re-calculated. The re-calculated hash value of the root node is stored in the secure memory 55 as the authentication hash value of the counter group 1 (71) (step S710).

Next, App1 (41) receives setting completion notification (step S711), and also gives the setting completion notification to the secure module 2 (60) via App2 (42) (steps S712 and S713).

Finally, the counter control unit 63 of the secure module 2 (60) sets the shared counter information in the counter management table 300 managed by the counter control unit 63 (step S714).

Note that although at step S704 a counter in the counter group 2 (72) is selected as the counter to be shared, instead a new counter may be generated as the counter to be shared. The newly generated counter is added to the tree structure of the counter group 2 as a leaf node. The hash values of the intermediate node and the root nodes in the tree structure of the counter group 2 are re-calculated, and the re-calculated hash value of the root node may be stored in the secure memory 65 as the authentication hash value of the counter group 2 (72).

This concludes the description of the flow of counter sharing.

<Counter Group Tree Having Shared Counter>

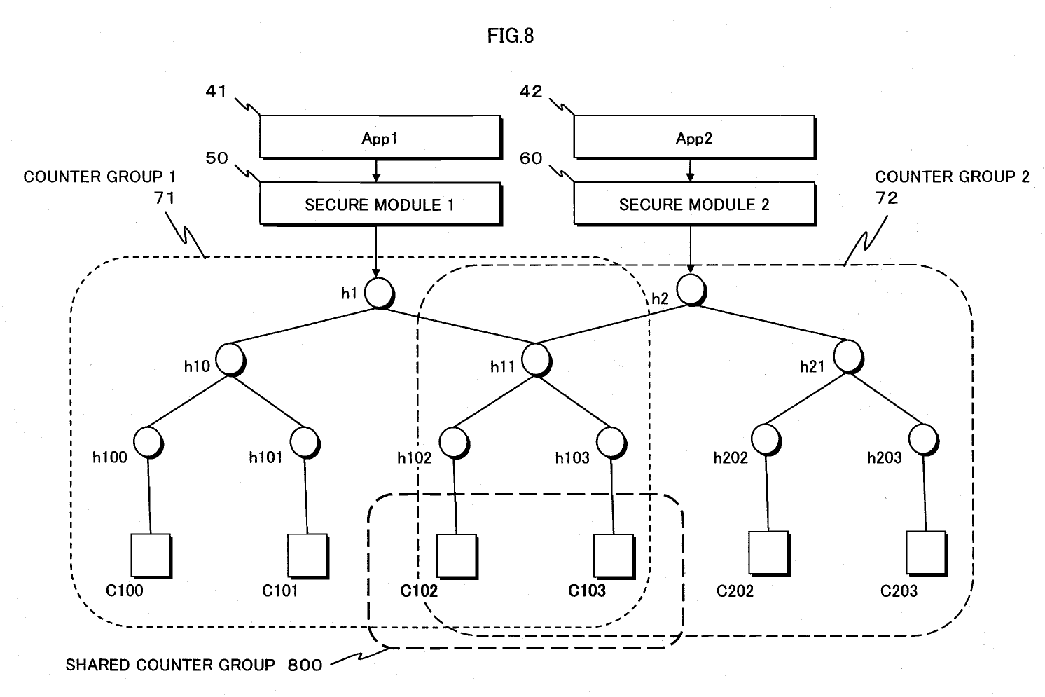

FIG. 8 shows an example of a tree structure in which a plurality of counters are shared by the counter group 1 (71) and the counter group 2 (72).

In the case shown in FIG. 8, the counter group 1 (71) used by App1 (41) and managed in the secure module 1 (50) has a tree structure composed of counters (C100, C101, C102, C103), intermediate nodes (h100, h101, h102, h103, h10, h11), and a root node (h1). The counter group 2 (72) used by App2 (42) and managed in the secure module 2 (60) has a tree structure composed of counters (C102, C103, C202, C203), intermediate nodes (h102, h103, h202, h203, h11, h21), and a root hash value (h2). The shared counters (800) are C102 and C103.

<Shared Counter Management Table>

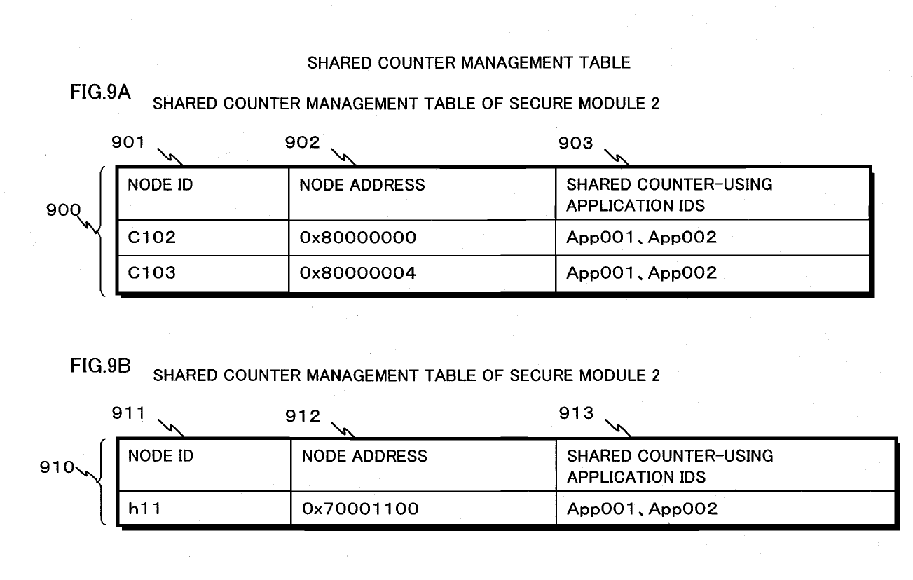

FIGS. 9A and 9B show shared counter tables managed by the counter control unit 63 of the secure module 2 (60) in the case of the shared counters shown in FIG. 8.

The shared counter table 900 is composed of a node IDs 901, node addresses 902, and shared counter-using application IDs 903. The node IDs 901 are pieces of identification information, each identifying a respective node in the counter group. The node addresses 902 are pieces of address information, each showing an address where the corresponding node in the counter group is stored in a memory. The shared counter-using application IDs 903 are pieces of identification information, each showing which applications are permitted to use the node shown by the corresponding piece of identification information in the node ID 901.

There are two conceivable data configurations for the shared counter table.

FIG. 9A is an example of the shared counters “C102” and “C103” being registered in the shared counter management table 900. In this case, the shared counter C102 is located at the address “0x80000000”, the shared counter C102 is located at the address “0x80000004”, and these two counters are shared by App1 (41) and App2 (42). If a data configuration such as that shown in FIG. 9A is used, the applications that each counter is permitted to be used by can be specified individual with respect to each counter. This allows detailed control of counter sharing.

FIG. 9B is an example of the h11, which is the parent node of the shared counters, being registered as the shared counter management table 910. In this case, tracing from “C102” and “C103” toward the root, the node ID “h11” that includes both C102 and C103 is registered in the shared counter management table 910. The shared counter management table 910 shows that “h11” is located at the address “0x70001100”, and that “h11” is shared by App1 (41) and App2 (42). Here, if “h11” is able to be shared, this shows that the nodes from the node of “h11” through to the leaf nodes thereof, namely “h11”, “h102”, “h103”, “C102” and “C103” are able to be accessed by App1 (41) and App2 (42). If the data configuration of FIG. 9B is used, by designating a certain node all counters corresponding to leaf nodes that are descendants of the certain node can be shared as a result of a single setting. This makes management easier, particularly when there is a large number of counters. This configuration also keeps the size of the shared management table small.

<Shared Counter Shared by Three Counter Groups>

In FIG. 8 and FIG. 9, a description was given of an example of counters being shared by two groups. However, the number of groups sharing the counters is not limited to two, and counters may be shared by any number of counter groups.

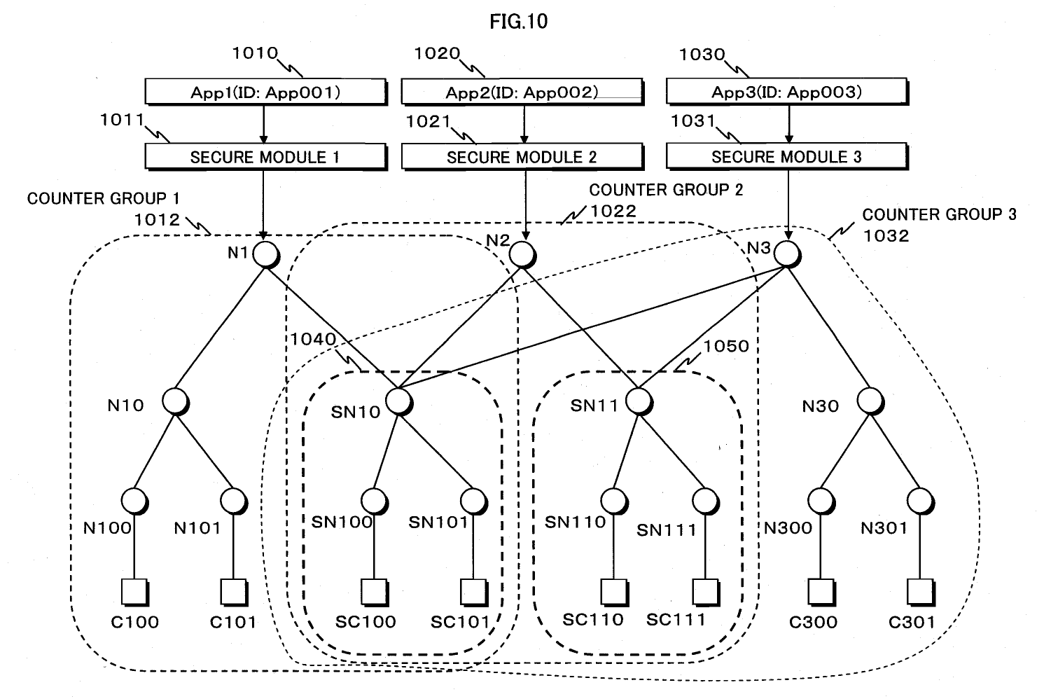

FIG. 10 shows an example of counters being shared by three counter groups, namely a counter group 1 (1012), a counter group 2 (1022), and a counter group 3 (1032).

App1 (1010) uses the counter group 1 (1012) via a secure module 1 (1011), App2 (1020) uses the counter group 2 (1022) via a secure module (1021), and App3 (1030) uses the counter group 3 (1032) via a secure module 3 (1031).

The counter group 1 (1012) has a tree structure composed of counters (C100, C101, SC100, SC101), intermediate nodes (N100, N101, SN100, SN101), and a root node (N1).

The counter group 2 (1022) has a tree structure composed of counters (SC100, SC101, SC110, SC111), intermediate nodes (SN100, SN101, SN110, SN111, SN10, SN11), and a root node (N2).

The counter group 3 (1032) is composed of counters (SC100, SC101, SC110, SC111, C300, C301), intermediate nodes (SN100, SN101, SN110, SN111, N300, N301, SN10, SN11, N30), and a root node (N3).

The shared counters in the case of FIG. 10 are the four counters SC100, SC101, SC110 and SC111.

The shared counter group 1040 is a counter group that is a tree composed of SN10, SN100, SN101, SC100 and SC101, and is shared by App1 (1010), App2 (1020) and App3 (1030).

The shared counter group 1050 is a counter group that is a tree structure composed of SN11, SN110, SN111, SC110 and SC111, and is shared by App2 (1020) and App3 (1030).

<Shared Counter Table of Secure Modules 1, 2 and 3>

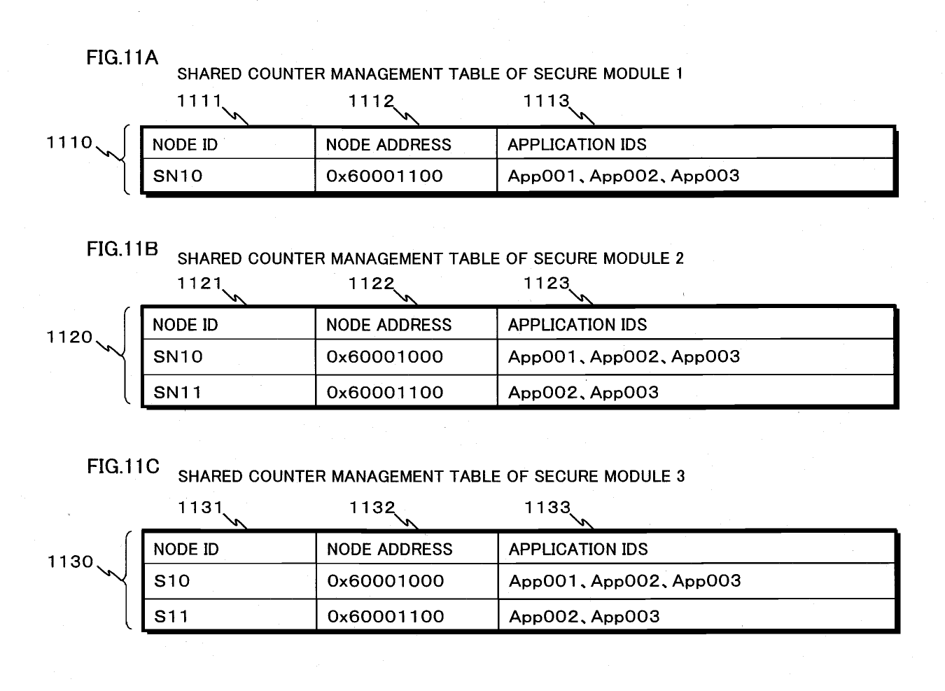

FIGS. 11A to 11C show what kind of shared counter management tables are used by the secure modules (1011, 1012, 1032) to manage the shared counters shown in FIG. 10.

FIG. 11A shows a shared counter management table 1110 held by the secure module 1 (1011). FIG. 11B shows a shared counter management table 1120 held by the secure module 2 (1021). FIG. 11C shows a shared counter management table 1032 held by the secure module 3 (1031). Each of the management tables 1110, 1120 and 1130 consists of the same items as shown in FIG. 9B, and therefore a description thereof is omitted here. By the respective counter control units of the secure modules managing the shared counter management tables in this way, more counters can be shared in a more complicated manner.

In this way, shared counters can be added with more flexibility and more easily.

Note that the shared counters are not limited to being managed using the IDs of the applications that use the shared counters. As one example, the shared counters may be managed using secure module IDs that are information identifying the secure modules.

Furthermore, although each one secure module corresponds to a counter group of one tree structure in the present embodiment, a single secure module may manage counter groups of two or more tree structures.

Furthermore, the counter groups are not limited to being in a plain text state as in the present embodiment. For instance, although not illustrated, a public key encryption key pair may be generated for each secure counter group, and the counter group managed by each secure module may be stored in a state of having been signed with a the public key. Alternatively, instead of being signed, each secure module may be stored in an encrypted state, having been encrypted using a symmetric encryption scheme such as AES encryption. A further alternative is to give a signature only to counter values that are leaf nodes in the counter group tree structure, or to encrypt only counter values that are leaf nodes in the tree structure. This makes it more difficult to tamper with the counter groups. More specifically, the method disclosed in Non-Patent Document 2 may be used if a secure module is realized by a TPM. Details of this are given in Non-Patent Document 2, and therefore a description thereof is omitted.

Furthermore, in the present embodiment, although an application designates the counter ID of the target of reading or the target of incrementing in the counter read processing or the counter incrementing processing, an application ID that is identification information of the application may be simultaneously notified to the counter control unit.

<Shared Data Usage Service System in a Multi-Stake Holder Model>

A description is now given of an implementation method that uses shared counters to prevent a backup restore attack of shared data. A backup restore attack is a malicious attack that backs up data at a certain point in time, and restores the backed up data to the memory. A specific type of data that may be the target of a backup restore attack is information that has value, such as electronic money (herein after, such information is referred to as a “value”). In particular, in the case of prepaid electronic money, a user pays cash in advance, and information corresponding to the amount the user paid is written in a terminal as a value. The user can purchase certain goods and/or services by using the value. In a backup restore attack, data of the value is backed up prior to the value being used, and then after the certain goods and/or services have been purchased using the value in the terminal, the backed-up value is written to the terminal again in order to restore the value that has already been used. By repeating this processing, a malicious user can continue to use the value perpetually. Values such as electronic money are not the only targets of backup restore attacks. Rights information of music content or video content, such as information showing how many times the content is permitted to be played back or a time limit for playing back the content, may similarly be a target of a backup restore attack.

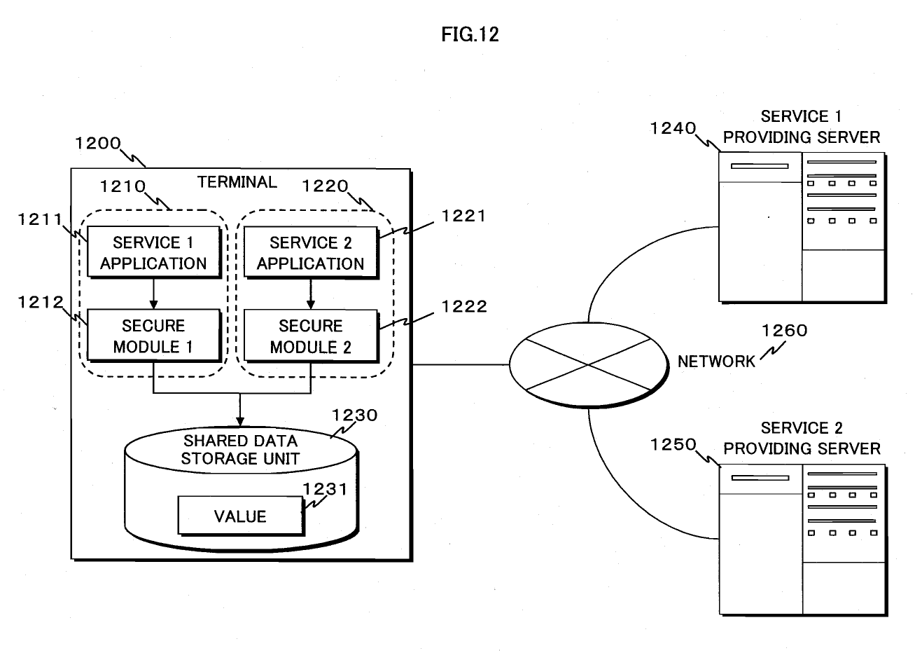

FIG. 12 shows a service system in which shared data is used by a plurality of service applications to receive a network service.

A terminal 1200 connects to a service 1 providing server 1240 and a service 2 providing server 1250 via a network 1260.

The terminal 1200 has a service 1 application 1211 and a service 2 application 1221. Both of these applications use a value 1231 stored in a shared data storage unit 1230, and receives a service from the service 1 providing server 1240 and the service 2 providing server 1250.

The service 1 application 1211 uses a secure module (1212) to access the value 1231 and receive a desired service from the service 1 providing server 1240. The service 2 application 1221 uses a secure module 2 (1222) to access the value 1231 and receive a desired service from the service 2 providing server 1250.

Here, the service 1 application (1211) and the secure module 1 (1212) are provided by a service providing company 1, and the service 2 application (1220) and the secure module 2 (1222) are provided by a service providing company 2. A model in which a single terminal is installed with software of a plurality of enterprises is called a multi-stakeholder model in MTM.

A description is now given of a method for preventing a backup restore attack, using shared counters that are shared by two stakeholders—the service 1 application 1211 and the secure module 1 (1212) being one stakeholder environment 1210, and the service 2 application 1220 and the secure module 2 (1222) being another stakeholder environment 1220.

<Time Variable Key Pre-Processing>

In the present embodiment, measures are taken against a backup restore attack by encrypting the shared data with a time variable key. Here, “time variable key” refers to an encryption key of which the value varies each time a certain period of time elapses. The following describes the method used to generate and use the time variable key.

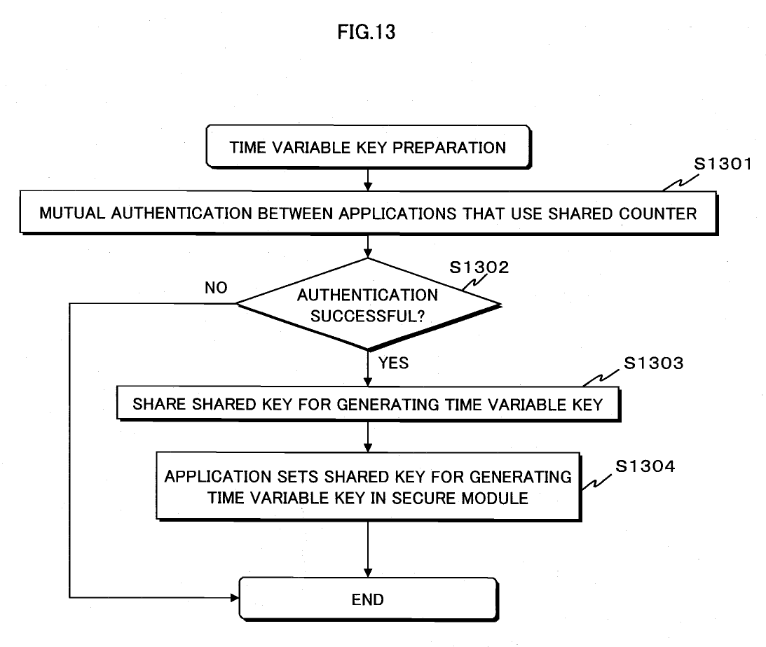

FIG. 13 is a flowchart showing preparation processing for using the time variable key.

First, applications that use the shared counters authenticate each other (step S1301). The mutual authentication method is the same as that in FIG. 7.

Next, the result of the mutual authentication of step S1301 is judged (step S1302).

If the result of the mutual authentication is “NO” (i.e., that authentication failed), this is treated as an error in the time variable key preparation processing, and the processing ends.

On the other hand, if the result of mutual authentication is “YES” (i.e., that authentication is successful), the processing moves to step S1303.

Next, the mutually authenticated applications hold a shared key for use in generating the time variable key (step S1304). Each of the applications generates a shared key by generating a random number, and holds the generated shared key. Although not illustrated, the random number may be generated by a random number generator, or may be obtained by calculation. Note that although the shared key for generating the time variable key is key data here, the shared key is not limited to this and may be data information usable only by applications that use the shared counters.

Finally, the shared key for generating the time variable key is set as a shared key in the secure modules used by the applications (step S1305). Specifically, the shared key for generating the time variable key is set in the secure memory of the secure module.

Note that the processing to generate the shared key for generating the time variable key, and the processing to set the shared key for generating the time variable key in the secure memory of the secure module need only be performed once between the applications that use the shared counters. This processing is, however, not limited to being performed only once and may be performed each time the shared data is accessed.

Note also that the method of setting the shared key for generating the time variable key is not limited to the described method. The shared key for generating the time variable key may be embedded in the secure modules in advance. Hereinafter, the shared key for generating the time variable key is abbreviated to “shared key”.

<Encryption and Decryption Processing of Shared Data Using Time Variable Key>

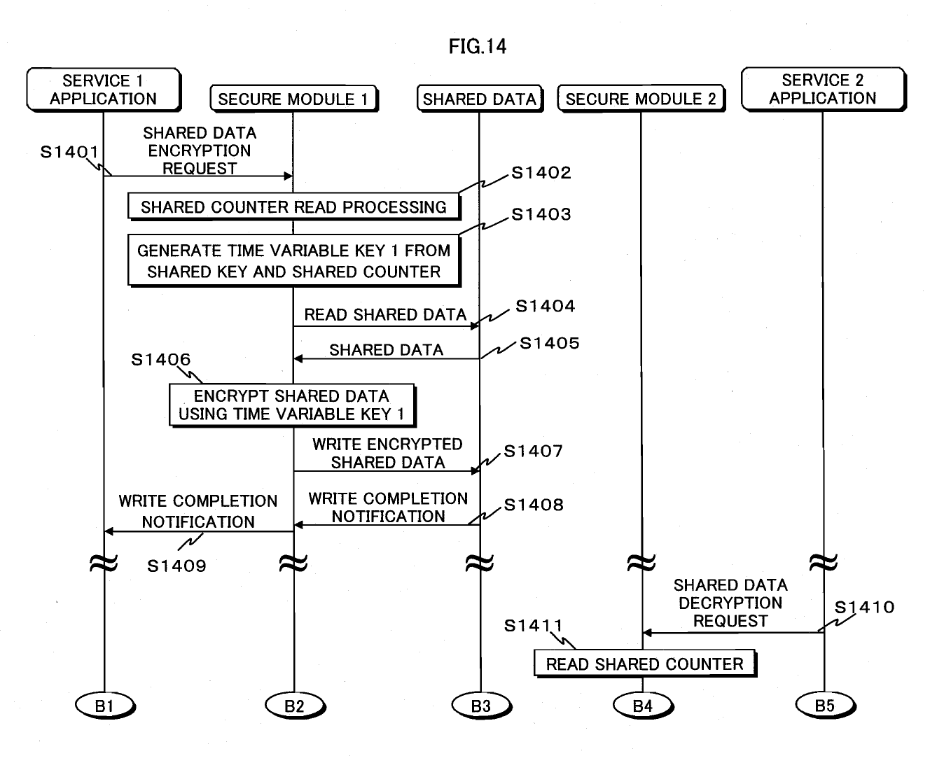

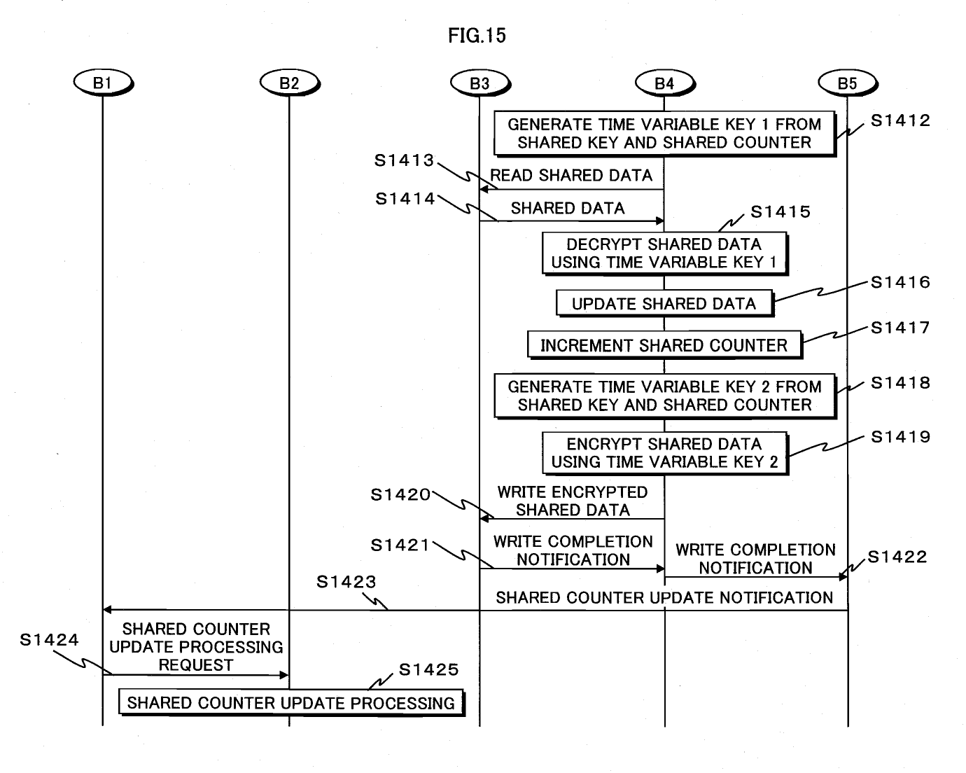

Referring to FIG. 14 and FIG. 15, a description is now given of encryption and decryption processing of shared data using the time variable key.

Steps S1401 to S1409 are steps for encrypting the shared data using the time variable key.

First, the service 1 application 1211 makes a shared data encryption request to the secure module 1 (1212) (step S1401).

Next, the secure module 1 (1212) performs shared counter read processing (step S1402). The counter read processing is as described in FIG. 4, and therefore a description thereof is omitted here.

Next, the secure module 1 (1212) generates a time variable key from the read shared counter value and the shared key (step S1403). More specifically, a SHA1 algorithm is used to calculate a hash value of data generated by concatenating the shared counter and the shared key. Then, a key to use to encrypt the shared data is generated from the calculated hash value, this generated key is used as the time variable key. Here, it is assumed that the encryption algorithm and the information identifying the time variable key generation algorithm are attached to the header of the shared data. More specifically, when AES (key length of 128 bits) is used for the encryption algorithm and SHA1 is used as the time variable key generation algorithm, information by which each of these algorithms can be identified is put in association. In this case, the secure module refers to the header of the shared data, concatenates the values of the shared counter and the shared key, and calculates a 160-bit hash value using SHA1. The upper 128 bits of the calculated hash value are used as the time variable key.

Note that the method used to generate the time variable key is not limited to the described method. Any method whereby the applications that access the shared data can generate a same key from a same shared counter and shared key may be used.

Next, the secure module 1 (1212) reads the shared data that is the target of encryption (steps S1404 and S1405).

The read shared data is encrypted using a time variable key 1 generated at step S1403 (step S1406).

The encrypted data is written as shared data (step S1407)

The service application 1 (1211) receives write completion notification (steps S1408 and S1409), and the shared data encryption processing ends.

A description is now given steps S1410 to S1424 for decrypting the shared data encrypted using the time variable key 1.

First, the service 2 application 1221 makes a shared data encryption request to the secure module 2 (1222) (step S1410).

Next, the secure module 2 (1222) performs shared counter read processing (step S1411). The counter read processing is as described in FIG. 4, and therefore a description thereof is omitted here.

The secure module 1 (1212) then generates the time variable key 1 from the read value of the shared counter and the shared key (step S1412). The method used to generate the time variable key is the same as at step S1403, and therefore a description thereof is omitted.

The secure module 2 (1222) then reads the shared data that is the target of decryption (steps S1413 and S1414), and decrypts the shared data using the time variable key generated at step S1412 (step S1415).

Next, the shared data is updated (step S1416). Since the present embodiment uses a model in which the shared data is a value and a service is received by using the value, the shared data is updated to reflect the used value.

Next, the service 2 application 1221 increments the shared counter (step S1417). The processing for incrementing the shared counter is the same as the processing described in FIGS. 5 and 6, and therefore a description thereof is omitted here.

The service 2 application 1221 then generates a time variable key 2 that is different to the time variable key 1, from the incremented shared counter and the shared key (step S1418). The method used to generate the time variable key 2 is the same as at step S1403, and therefore a description thereof is omitted here.

Next, the updated shared data is encrypted using the time variable key 2 generated at step S1418 (step S1419).

The shared data encrypted using the time variable key 2 is written to the shared data storage unit (step S1420).

The service 2 application 1221 receives write completion notification (steps S1421 and S1422).

The service 2 application 1221 refers to the application IDs in the shared counter management table managed by the secure module 2 (1222), to specify the applications that are using the incremented shared counter, and issues notification to the specified applications that the shared counter has been updated. Here, the service 2 application 1221 notifies the service 1 application 1211 that the shared counter has been updated (step S1423).

Next, the service 1 application 1211 makes a shared counter update processing request to the secure module 1 (1212) (step S1424).

The information of nodes other than the shared counter value managed by the secure module 1 (1212) are as before the shared counter was incremented, and therefore updating processing to update each of the nodes in the counter group of the tree structure managed by the secure module 1 (1212) and update processing to update the authentication hash value are performed (step S1425).

This concludes the description of the encryption and decryption processing of the shared data using time variable keys.

Note that the shared data is not limited to being a value such as electronic money in the present embodiment, and may be rights information of digital contents such as music or a movie, or may be private information such as an address list or personal information.

### Second Embodiment

In the second embodiment, a description is given of a shared counter access control method for cases such as when it is detected that a stakeholder application has been tampered with and when a stake holder application is updated.

<Updating System>

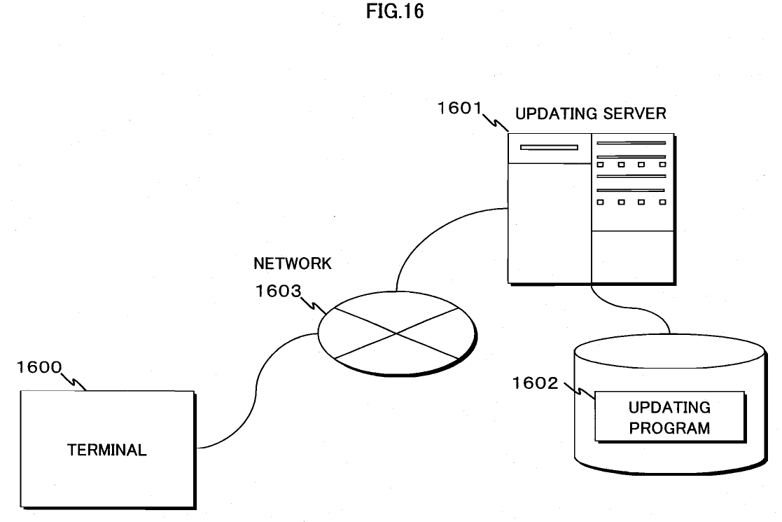

FIG. 16 shows an updating system for updating a stakeholder application in a terminal 1600.

The terminal 1600 is connected to a network 1603, and downloads an updating program for updating a stakeholder application in a terminal from an updating server 1601.

Each stakeholder application is in association with an application identifier, version information, and the like. The terminal 1600 notifies the updating server of stakeholder environment information (application identifier, version information, and the like) in the terminal, and downloads an appropriate updating program.

Note that although the description is of notifying stakeholder environment information (application identifier, version information, and the like) of the stakeholder application in the terminal, the updating may be performed using attestation processing defined by the TCG standard. Since details of attestation processing are stipulated in the TCG standard, a description thereof is omitted here.

<Overall Terminal Structure>

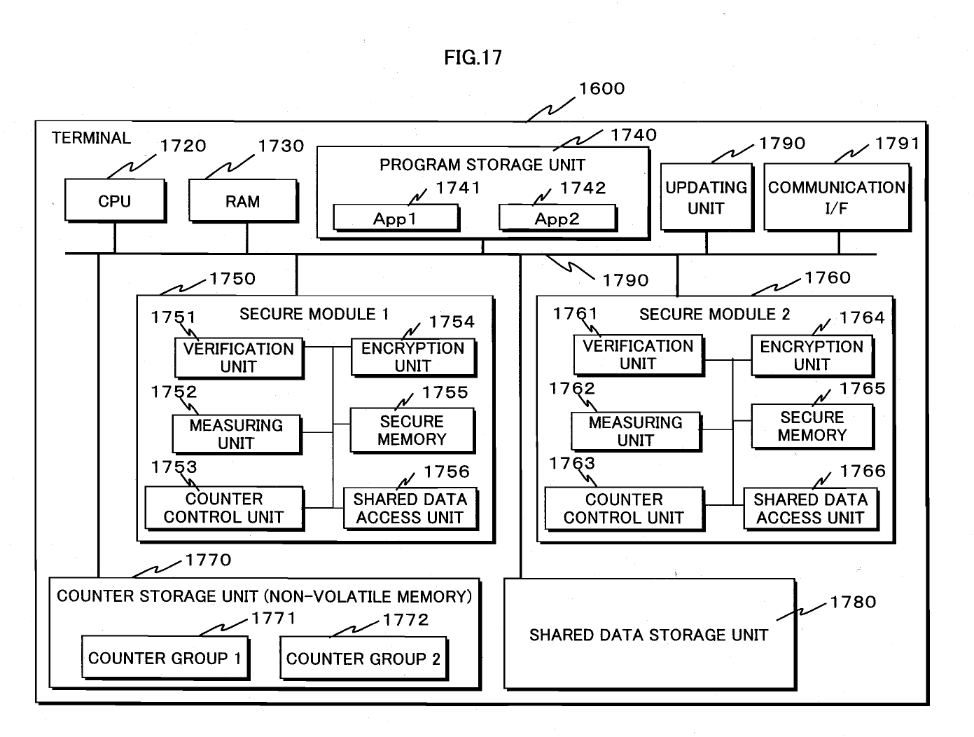

FIG. 17 is an overall structural drawing of the terminal 1600 in the second embodiment. Since the majority of the structural components of the terminal 1600 are the same as in FIG. 1 in the first embodiment, only the structural components not present in FIG. 1 are described.

The structural components in FIG. 17 that are not present in FIG. 1 are an updating unit 1790 and a communication interface (I/F) 1791.

The communication I/F 1791 is an interface for performing transmission and reception of data between the terminal 1600 and an external terminal. In the present embodiment, the communication I/F 1719 performs transmission and reception of data with the updating server 1601.

The updating unit 1790 issues a download request to download an updating program to update App1 (1741) and App2 (1742), and using the downloaded update program, performs update processing with respect to App1 (1741) or App2 (1742) stored in the program storage unit.

<Shared Counter Access Permission Setting>

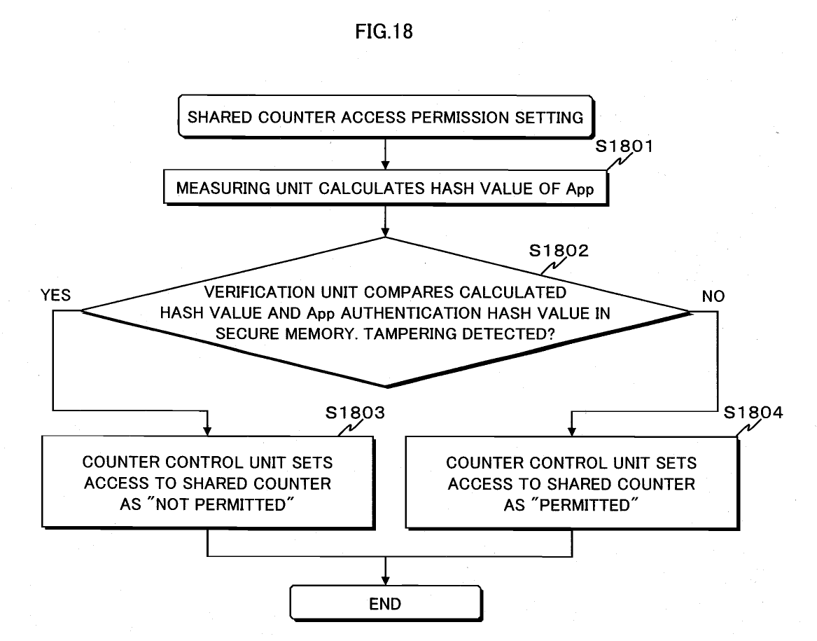

Referring to FIG. 18, a description is now given of application tampering check processing and shared counter access permission setting processing.

In the present embodiment, the authentication hash value of App1 (1741) is stored in the secure memory of the secure module 1, and App2 (1742) is stored in the secure memory of the secure module 2. Note that instead of the authentication hash value, a certificate such as an X.509 certificate may be stored in the secure memory. It is assumed here that if a certificate is stored in the secure memory, the certificate includes an authentication hash value.

First, the measuring unit of the secure module calculates a hash value of an application stored in the program storage unit (step S1801).

Next, the verification unit of the secure module compares the authentication hash value in the secure memory and the hash value calculated at step S1801, to check for tampering (step S1802).

When the result of the judgment at step S1802 is “YES” (i.e., when tampering is detected), the counter control unit of the secure module makes a setting showing that access to the shared counter is not permitted from the application (step S1803)

When, on the other hand, the result of the judgment is “NO” (i.e., when tampering is not detected), the counter control unit of the secure module makes a setting showing that access to the shared counter is “permitted” from the application (step S1804).

In the present embodiment, the secure module 1 (1750) performs the tamper check of App1 (1741), and the secure module 2 (1760) performs the tamper check of App1 (1742).

By making a setting to permit or not permit access to the shared counter in this way as a result of the tamper check, it is possible to prevent access to the shared counter from a malicious application that has been tampered with. With regard to the timing with which the tamper check is performed, the tamper check may be performed when the terminal is booted, periodically during execution of the application, or when triggered by specific processing.

<Shared Counter Table after Detecting Tampering of an Application>

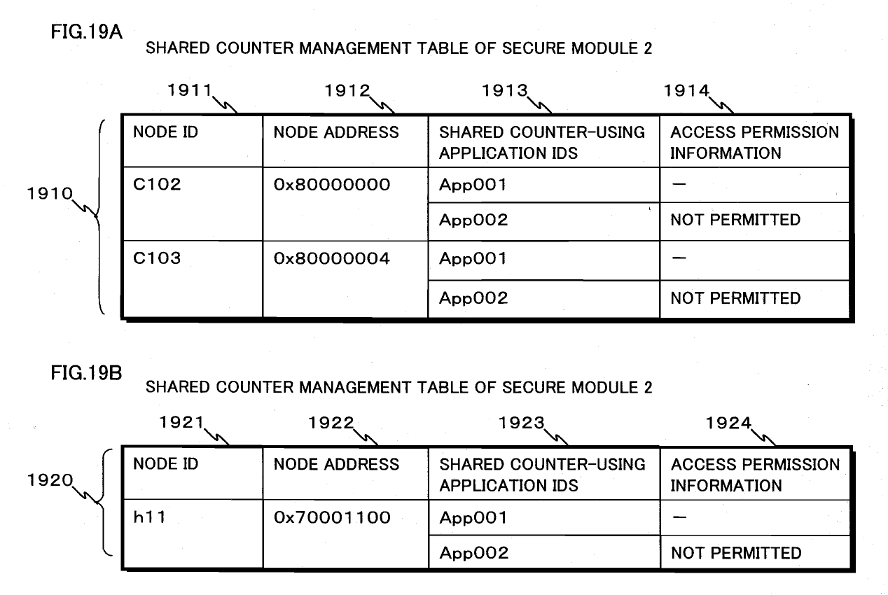

FIGS. 19A and 19B show examples of the shared counter table after the secure module has performed a tamper check of an application. More specifically, FIGS. 19A and 19B show that state of shared counter tables managed by the counter control unit 1663 after the secure module 2 (1760) performs a tamper check of App2 (1742) based on the flow of FIG. 18 with the shared counters in the state of FIG. 8 of the first embodiment. A description of elements of the shared counter tables (1910 and 1920) that are the same as in FIG. 9 is omitted. The shared counter tables (1910 and 1920) in FIG. 19 additionally include access permission information (1914 and 1924).

Either “permitted” or “not permitted” is set in each piece access permission information (1914 and 1924), showing a status of access permission to the shared counter.

FIG. 19A corresponds to FIG. 9A, and shows a state in which as a result of a tamper check of App2 (1742), App2 (1742) has judged to have been tampered with and is prohibited from accessing the shared counters “C102” and “C103”. FIG. 19B corresponds to FIG. 9B, and shows a state in which as a result of a tamper check of App2 (1742), App2 (1742) has judged to have been tampered with and is prohibited from accessing the shared counters “C102” and “C103”.

<Flow of Updating Via the Network>

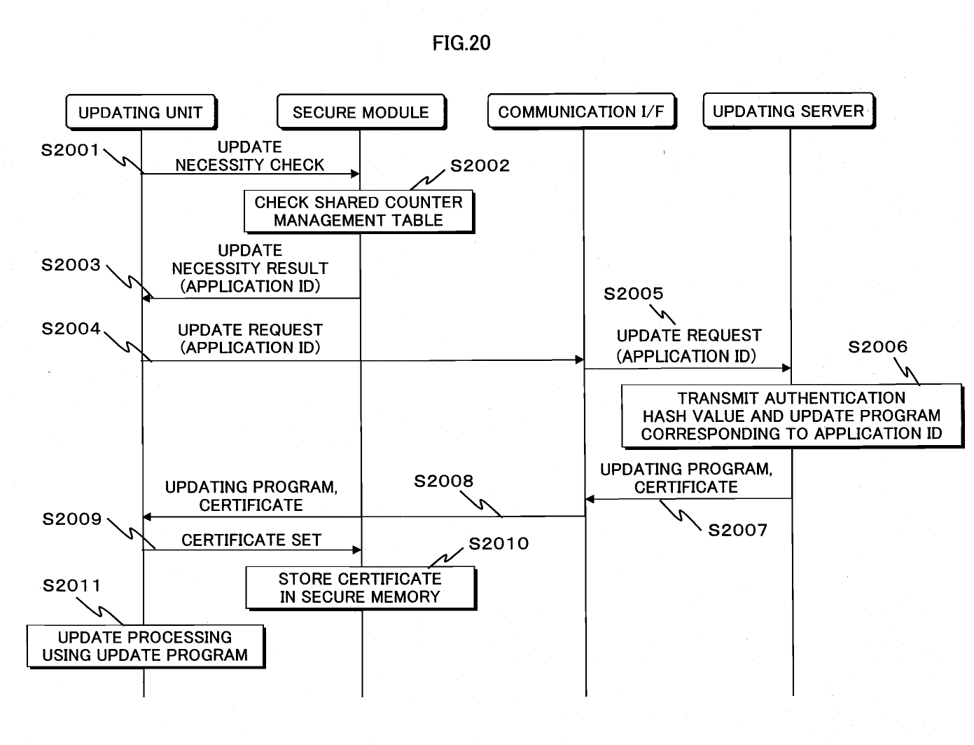

FIG. 20 is a flowchart of the updating unit 1790 updating an application via the network.

First, the updating unit 1790 notifies the secure module to check whether or not updating is necessary (step S2001).

Next, the secure module checks the shared counter management table (step S2002). More specifically, the secure module refers to the access permission information (1914, 1924), and returns an application ID for which “not permitted” is set to the updating unit 2003 (step S2002). If App2 (1742) is “not permitted” as in FIG. 19, the secure module returns the application ID “App002” of App2 (1742).

The updating unit 1790 outputs the application ID and an update request to the updating server 1601 via the communication I/F 1719 in order to update the application corresponding to the received application ID (steps S2004 and S2005).

The updating server 1601 transmits an updating program corresponding to the received application ID and a certificate of the updating program to the terminal 1600 (step S2007). Although not illustrated, the certificate includes a hash value of the updating program. The certificate is used to verify the integrity of the updating program.

The terminal 1600 receives the updating program and the certificate from the updating server 1601 via the communication I/F 1791 (steps S2007 and S2008).

The updating unit 1790 issues a request to the secure module to store the received certificate to the secure memory (step S2009).

The secure module stores the certificate to the secure memory (step S2009).

Lastly, using the updating program, the updating unit 1790 updates the application that is the updating target (step S2010).

According to the described flow, an application that uses the secure module can be updated via a network.

Note that although in the present embodiment a request to download the updating program is issued to the updating server 1601 via the network triggered by referring to an application for which the access permission information (1914, 1924) in the shared counter table is set to “not permitted”, the timing with which the download request is made is not limited to this. The download request may be issued when a message is received from the updating server 1601 or when the terminal is booted. Alternatively, an application may be examined for tampering periodically while being executed, and a request may be issued to download the updating program 1602 when the application is found to have been tampered with.

### Modification Examples

The present invention has been described based on, but is not limited to, the above embodiment. Cases such as the following are included in the present invention.

(1) Each described device is, specifically, a computer system composed of a microprocessor, a ROM, a RAM, a hard disk unit, a display unit, a keyboard, a mouse, and the like. A computer program is stored in the RAM or the hard disk unit. The computer program is composed of a plurality of instruction codes showing instructions with respect to a computer in order to have predetermined functions achieved. Each device achieves predetermined functions by the microprocessor operating according to the computer programs. In other words, the microprocessor reads one of the instructions included in the computer program at a time, decodes the read instruction, and operates in accordance with the result of the decoding. Note that each device is not limited to being a computer system composed of a microprocessor, a ROM, a RAM, a hard disk unit, a display unit, a keyboard, a mouse, and the like, but may instead be composed of some of the stated components.

(2) All or part of the compositional elements of each apparatus may be composed of one system LSI (Large Scale Integrated circuit). The system LSI is a super-multifunctional LSI on which a plurality of compositional units are manufactured integrated on one chip, and is specifically a computer system that includes a microprocessor, a ROM, a RAM, or the like. A computer program is stored in the RAM. The system LSI achieves its functions by the microprocessor operating according to the computer program.

Furthermore, the units that are the compositional elements of each of the devices may be realized separately with individual chips, or part or all may be included on one chip.

Here, the LSI may be an IC, a system LSI, a super LSI, or ultra LSI, depending on the degree of integration. Furthermore, the integration of circuits is not limited to being realized with LSI, but may be realized with a special-purpose circuit or a general-use processor. Alternatively, the integration may be realized with use of an FPGA (field programmable gate array) that is programmable after manufacturing of the LSI, or a re-configurable processor that enables re-configuration of the connection and settings of circuit cells in the LSI.

Furthermore, if technology for an integrated circuit that replaces LSIs appears due to advances in or derivations from semiconductor technology, that technology may be used for integration of the functional blocks. Bio-technology is one possible application.

(3) Part or all of the compositional elements of each apparatus may be composed of a removable IC card or a single module. The IC card or the module is a computer system composed of a microprocessor, a ROM, a RAM, or the like. The IC card or the module may be included the aforementioned super-multifunctional LSI. The IC card or the module achieves its functions by the microprocessor operating according to computer program. The IC card or the module may be tamper-resistant.

(4) The present invention may be methods shown by the above. Furthermore, the methods may be a computer program realized by a computer, and may be a digital signal of the computer program.

Furthermore, the present invention may be a computer-readable recording medium such as a flexible disk, a hard disk, a CD-ROM, an MO, a DVD, a DVD-ROM, a DVD-RAM, a BD (Blu-ray Disc) or a semiconductor memory, that stores the computer program or the digital signal. Furthermore, the present invention may be the computer program or the digital signal recorded on any of the aforementioned recording media.

Furthermore, the present invention may be the computer program or the digital signal transmitted on a electric communication network, a wireless or wired communication network, a network of which the Internet is representative, or a data broadcast.

Furthermore, the present invention may be a computer system that includes a microprocessor and a memory, the memory storing the computer program, and the microprocessor operating according to the computer program.

Furthermore, by transferring the program or the digital signal to the recording medium, or by transferring the program or the digital signal via a network or the like, the program or the digital signal may be executed by another independent computer system.

(5) The present invention may be any combination of the above-described embodiment and modifications.

(6) An information security device of the present invention comprises: a program storage unit operable to store a first program and a second program; a first counter group composed of at least one counter used by the first program group; a second counter group composed of at least one counter used by the second program; a counter storage unit operable to store the first counter group and the second counter group; first counter authentication information that is information for showing integrity of the first counter group; second counter authentication information that is information for showing integrity of the second counter group; a secure memory operable to store the first counter authentication information or the second counter authentication information; a measuring unit operable to calculate (i) first counter calculation information that is a value compared with the first counter authentication information in order to verify integrity of the first counter group or (ii) second counter calculation information that is a value compared with the second counter authentication information in order to verify the integrity of the second counter group; a verification unit operable to compare the first counter calculation information calculated by the measuring unit with the first counter authentication information, or compare the second counter calculation information with the second counter authentication information; a counter control unit operable to, in accordance with a result of the comparison by the verification unit, control access to the first counter group by the first program, or control access to the second counter group by the second program; and at least one shared counter whereby at least one counter in the first counter group is a counter in the second counter group, and at least one counter in the second counter group is a counter in the first counter group.

According to the stated structure, it is possible to provide a counter that is in both the first counter group used by the first program and the second counter group used by the second program, and is usable by the first program and the second program. Furthermore, there is no need to store the entire counter groups securely in the secure memory. Instead, it is sufficient to store only the counter authentication information generated from the counter groups. Therefore, the necessary secure memory size can be curbed. In addition, although prior art realized secure counters by implementing counters in hardware, the present invention makes it possible to construct a counter group having a plurality of counters outside the secure memory, and therefore the number of counters can be designed flexibly.

Furthermore, in the information security device of the present invention, each of the first counter group and the second counter group may have a tree structure in which a hash value is arranged at a parent node and values of the counters are arranged at leaf nodes, the hash value being information for showing integrity of data as the result of concatenating data stored by child nodes.

According to the stated structure, by merely sharing intermediate nodes in the tree structure, settings such as adding, deleting and revoking counters can be performed flexibly. The stated structure also makes it easy to manage which programs each shared counter is shared by.

Furthermore, in the information security device of the present invention, the counter control unit may include a counter management table, wherein the counter management table includes node identification information identifying nodes in the counter group 1 or the counter group 2, and program identification information identifying programs that can access the nodes.

According to the stated structure, it is possible to use the program identification information to manage which programs can use the counters.

Furthermore, in the information security device of the present invention, the counter management table may include node identification information relating to the at least one shared counter, and program identification information for identifying which programs can access the at least one shared counter.

According to the stated structure, it is possible to use the program identification information to manage which programs can used the counters, and settings such as adding, deleting and revoking counters can be performed flexibly.

Furthermore, in the information security device of the present invention, the counter management table may store in correspondence program identification information for identifying programs that can access the at least one shared counter and access permission information showing permission/prohibition of accessing the at least one shared counter, the secure memory stores program authentication information for verifying integrity of a program that uses the at least one shared counter, the measuring unit calculates program calculation information that is compared with the program authentication information for verifying the integrity of a program, the verification unit compares the program calculation information and the program verification information, the counter control unit sets “access permitted” in the access permission information corresponding to the program information of the program that is the target of integrity verification by the measuring unit and the verification unit when having received result information from the verification unit showing that the result of the verification is “equal”, and sets “access prohibited” in the access permission information corresponding to the program information of the program that is the target of integrity verification by the measuring unit and the verification unit when having received result information from the verification unit showing that the result of the verification is “not equal”.

According to the stated structure, when a program that can use a shared counter has been tampered with, the program that has been tampered with can be restricted from accessing the shared counter.

Furthermore, the information security device of the present invention may comprise an updating unit for updating a program, wherein the updating unit performs updating processing of a program corresponding to program identification information for which “access prohibited” is set in the access permission information in the shared counter management table.

According to the stated structure, when a program that can use the shared counter has been tampered with, the access permission information can be referred to check whether or not a program to be updated exists in the terminal. In addition, the update unit updates a program that has been tampered with when such a program is found to exist in the terminal, and therefore, a secure environment can be maintained in the terminal.

Furthermore, the information security device of the present invention may comprise a secure module, wherein the secure module is tamper resistant, and includes the measuring unit, the verification unit, the counter control unit, and the secure memory.

According to the stated structure, the units that relate to counter operations are made tamper resistant, and therefore the counters can be implemented more securely.

Furthermore, the information security device of the present invention may include at least two of the secure module.

According to the stated structure, a shared counter can be constructed so as to be shared by a plurality of secure modules. Furthermore, it is possible to prevent a backup restore attack of shared data shared by secure modules using the shared counter.

Furthermore, in the information security device of the present invention, the secure module may include: a key generation unit and an encryption unit, and the information security device may comprise: shared data shared by the secure modules; and a shared data storage unit operable to store shared data, wherein the key generation unit generates a shared data encrypted key using the shared counter, and subjects the shared data to encryption and decryption processing with the shared data encrypted key.

According to the stated structure, the shared data can be managed even more securely. More specifically, in rights management information in a DRM application, a malicious user may make a backup of rights information before using the rights information, and then when the rights have been used, restore the backed up rights information. The stated structure prevents a backup restore attack by which rights would otherwise never be used.

Furthermore, the information security device of the present invention may be realized by a TPM specified by Trusted Computing Group (TCG).

According to the stated structure, the information security device of the present invention can construct a secure execution environment, and control of the counters can be executed more securely.

Furthermore, in the information security device of the present invention, the secure module may be realized by an MTM specified by Trusted Computing Group (TCG).

According to the stated structure, the information security device of the present invention can be implemented in a mobile phone. Furthermore, counters can be shared by multi stakeholders, which are a feature of MTM. Furthermore, stated structure prevents a backup restore attack against shared data used by multi stake holder using a shared counter.

Furthermore, a counter control method of the present invention comprises: a step of storing to a counter storage unit a first counter group composed of at least one counter, and a second counter group composed of at least one counter; a step of accessing the first counter group or the second counter group from the counter storage unit; a step of sharing a first counter included in the first counter group and a second counter included in the second counter group; a step of reading the counters shared in the sharing step; and a step of incrementing a value of the counters shared in the sharing step.

According to the stated structure, counters that can be shared by two counter groups can be provided, and processing for reading the shared counters and incrementing a value of the shared counters are possible.

Furthermore, the counter control method of the present invention may comprise: a step of verifying integrity of a program that accesses the shared counters; a step of permitting the program to access to the shared counters when, as a result of the integrity verification step, it is judged that the program has been tampered with; a step of prohibiting access to the shared counters when, as a result of the integrity verification step, it is judged that the program has been tampered with.

According to the stated structure, verification is performed of the integrity of a program that accesses the shared counters, and only a program that is found to not have been tampered with can use the shared counters. Furthermore, when a program is judged to have been tampered with, usage of the shard counters by the program is restored when the program is updated normally. Therefore, even if a program is damaged unintentionally by the user, the damaged program can be updated and thus use the counters again.

Although the present invention has been fully described by way of examples with reference to the accompanying drawings, it is to be noted that various changes and modification will be apparent to those skilled in the art. Therefore, unless otherwise such changes and modifications depart from the scope of the present invention, they should be construed as being included therein.

### INDUSTRIAL APPLICABILITY

The counter control method of the present invention that relates to a counter group having a tree structure enables secure counters to be shared by a plurality of secure modules. Furthermore, the counter control method that performs sharing settings in counters in a tree structure allows operations such as adding shared counters, share settings and canceling of sharing to be made easily, and allows complicated share settings. The present invention also prevents a malicious restore attack on shared data.

What is claimed is:

1. An information processing device, comprising:
a program storage unit operable to store therein a first program and a second program;
a counter storage unit operable to store therein a first counter group composed of one or more counters used by the first program, and a second counter group composed of one or more counters used by the second program, the first counter group and the second counter group sharing at least one shared counter used by both the first program and the second program;
a counter verification unit operable to perform verification of integrity of the first counter group and verification of integrity of the second counter group; and
a counter control unit operable to prohibit the first program from accessing the at least one shared counter when verification of the integrity of the first counter group fails, and prohibit the second program from accessing the at least one shared counter when verification of the integrity of the second counter group fails.

2. The information processing device of claim 1, further comprising:
a storing unit operable to store therein access permission information showing whether or not the first program is permitted to access the at least one shared counter and whether or not the second program is permitted to access the at least one shared counter;
a program verification unit operable to verify integrity of the first program and verify integrity of the second program; and
an access management unit operable to, when the verification of at least one of the integrity of the first program and the integrity of the second program fails, update the access permission information such that the access permission information shows that the at least one of the first program and the second program for which the verification of integrity failed is prohibited from accessing the at least one shared counter,
wherein the counter control unit is further operable to prevent, from accessing the at least one shared counter, the at least one of the first program and the second program shown as being prohibited from accessing the at least one shared counter in the access permission information.

3. The information processing device of claim 2, comprising:
a first secure module that is tamper resistant; and
a second secure module that is tamper resistant,
wherein the counter verification unit includes:
a first counter verification unit operable to perform the verification of the integrity of the first counter group; and
a second counter verification unit operable to perform the verification of the integrity of the second counter group,
wherein the first counter verification unit is included inside the first secure module, and the second counter verification unit is included inside the second secure module.

4. The information processing device of claim 3, controlling the first counter group with use of a first tree structure and controlling the second counter group with use of a second tree structure,
wherein the counters in the first counter group are assigned in one-to-one correspondence to leaves in the first tree structure, and the counters in the second counter group are assigned in one-to-one correspondence to leaves in the second tree structure,
the first counter verification unit includes:
a verification value calculation sub-unit operable to calculate a first root verification value that is a verification value allocated to the root of the first tree structure, by performing the following procedure repeatedly in a direction from the leaves toward the root with respect to each node in the first tree structure other than the leaves: (a) calculating a verification value from a value of one child node of said node, and (b) allocating the calculated verification value to said node;
a secure memory operable to pre-store therein a first root authentication value equal to the first root verification value obtained when the first counter group has not been tampered with; and
a judgment sub-unit operable to judge that the verification of the integrity of the first counter group has failed when the first root verification value and the first root authentication value are not equal,
the second counter verification unit includes:
a verification value calculation sub-unit operable to calculate a second root verification value that is a verification value allocated to the root of the second tree structure, by performing the following procedure repeatedly in a direction from the leaves toward the root with respect to each node in the second tree structure other than the leaves: (a) calculating a verification value from a value of one child node of said node, and (b) allocating the calculated verification value to said node;
a secure memory operable to pre-store therein a second root authentication value equal to the second root verification value obtained when the second counter group has not been tampered with; and
a judgment sub-unit operable to judge that the verification of the integrity of the second counter group has failed when the second root verification value and the second root authentication value are not equal.

5. The information processing device of claim 3, further comprising:
a shared data storage unit operable to store therein shared data that is information shared by the first program and the second program,
wherein the first secure module further includes:
a key generation sub-unit operable to generate an encryption key with use of a value of the at least one shared counter;
an encryption sub-unit operable to encrypt, with use of the encryption key, the shared data received from the first program; and
a write sub-unit operable to store the shared data, which is in an encrypted state, to the shared data storage unit, and
wherein the second secure module further includes:
a reading sub-unit operable to read the shared data from the shared data storage unit;
a key generation sub-unit operable to generate a decryption key with use the value of the at least one shared counter;
a decryption sub-unit operable to decrypt the shared data which is in the encrypted state, with use of the decryption key; and
a providing sub-unit operable to provide the shared data obtained as a result of the decryption to the second program.

6. The information processing device of claim 5, wherein
the first secure module, when the first program is prohibited from accessing the shared counter, is prohibited from generating the encryption key using the value of the at least one shared counter, and
the second secure module, when the second program is prohibited from accessing the shared counter, is prohibited from generating the decryption key using the value of the at least one shared counter.

7. The information processing device of claim 3, further comprising:
a shared data storage unit operable to store therein shared data that is information shared by the first program and the second program,
wherein the first program stores the shared data to the shared data storage unit via the first secure module,
the second program reads the shared data from the shared data storage unit via the second secure module,
the first secure module controls the first counter group with use of a first tree structure, the counters in the first counter group being assigned in one-to-one correspondence to leaves in the first tree structure,
the first counter verification unit includes:
a verification value calculation sub-unit operable to calculate a first root verification value that is a verification value allocated to the root of the first tree structure, by performing the following procedure repeatedly in a direction from the leaves toward the root with respect to each node in the first tree structure other than the leaves: (a) calculating a verification value from a value of one child node of said node, and (b) allocating the calculated verification value to said node;
a secure memory operable to pre-store therein a first root authentication value equal to the first root verification value obtained when the first counter group has not been tampered with; and
a judgment sub-unit operable to judge that the verification of the integrity of the first counter group has failed when the first root verification value and the first root authentication value are not equal,
wherein the first secure module further includes:
a key generation sub-unit operable to, when the verification of the first counter group is successful, generate an encryption key with use of a value of the at least one shared counter;
an encryption sub-unit operable to encrypt, with use of the encryption key, shared data received from the first program; and
a write sub-unit operable to write the shared data, which is in an encrypted state, to the shared data storage unit,
wherein the second secure module controls the second counter group with use of a second tree structure, and the counters in the second counter group are assigned in one-to-one correspondence to leaves in the second tree structure,
the second counter verification unit includes:
a verification value calculation sub-unit operable to calculate a second root verification value that is a verification value allocated to the root of the second tree structure, by performing the following procedure repeatedly in a direction from the leaves toward the root with respect to each node in the second tree structure other than the leaves: (a) calculating a verification value from a value of one child node of said node, and (b) allocating the calculated verification value to said node;
a secure memory operable to pre-store therein a second root authentication value equal to the second root verification value obtained when the second counter group has not been tampered with; and
a judgment sub-unit operable to judge that the verification of the integrity of the second counter group has failed when the second root verification value and the second root authentication value are not equal, and
wherein the second secure module further includes:
a key generation sub-unit operable to, when the verification of the integrity of the second counter group is successful, generate a decryption key with use the value of the at least one shared counter;
a decryption sub-unit operable to decrypt the shared data which is in the encrypted state, with use of the decryption key; and
a providing sub-unit operable to provide the shared data obtained as a result of the decryption to the second program.

8. The information processing device of claim 3, further comprising:
a program updating unit operable to, when the access permission information shows that at least one of the first program and the second program is prohibited from accessing the shared counter, update the at least one program shown as being prohibited from accessing the shared counter,
wherein the program verification unit is further operable to verify integrity of the at least one updated program, and
the access management unit, when the verification of the at least one updated program succeeds, updates the access permission information such that the access permission information shows that the at least one updated program is permitted to access the at least one shared counter.

9. The information processing device of claim 3, wherein the first module and/or the second module is realized by a TPM specified by Trusted Computing Group (TCG).

10. The information processing device of claim 3, wherein the first module and/or the second module is realized by an MTM specified by Trusted Computing Group (TCG).

11. An information processing method used in an information processing device, the information processing device including:
a program storage unit operable to store therein a first program and a second program; and
a counter storage unit operable to store therein a first counter group composed of one or more counters used by the first program, and a second counter group composed of one or more counters used by the second program, the first counter group and the second counter group sharing at least one shared counter used by both the first program and the second program,
the information processing method comprising the steps of:
performing verification of integrity of the first counter group and verification of integrity of the second counter group; and
prohibiting the first program from accessing the at least one shared counter when verification of the integrity of the first counter group fails, and prohibiting the second program from accessing the at least one shared counter when verification of the integrity of the second counter group fails.

12. A recording medium on which is recorded an information processing program used in an information processing device, the information processing device including:
a program storage unit operable to store therein a first program and a second program; and
a counter storage unit operable to store therein a first counter group composed of one or more counters used by the first program, and a second counter group composed of one or more counters used by the second program, the first counter group and the second counter group sharing at least one shared counter used by both the first program and the second program,
the information processing program causing the information processing device to perform the steps of:
performing verification of integrity of the first counter group and verification of integrity of the second counter group; and
prohibiting the first program from accessing the at least one shared counter when verification of the integrity of the first counter group fails, and prohibiting the second program from accessing the at least one shared counter when verification of the integrity of the second counter group fails.

13. An integrated circuit used in an information processing device, the integrated circuit comprising:
a program storage unit operable to store therein a first program and a second program;
a counter storage unit operable to store therein a first counter group composed of one or more counters used by the first program, and a second counter group composed of one or more counters used by the second program, the first counter group and the second counter group sharing at least one shared counter used by both the first program and the second program;
a counter verification unit operable to perform verification of integrity of the first counter group and verification of integrity of the second counter group; and
a counter control unit operable to prohibit the first program from accessing the at least one shared counter when verification of the integrity of the first counter group fails, and prohibit the second program from accessing the at least one shared counter when verification of the integrity of the second counter group fails.

14. An information processing device, comprising:
a program storage unit operable to store therein a first program and a second program;
a counter storage unit operable to store therein a first counter group composed of one or more counters used by the first program, and a second counter group composed of one or more counters used by the second program, the first counter group and the second counter group sharing at least one shared counter used by both the first program and the second program;
a storing unit operable to store therein access permission information showing whether or not the first program is permitted to access the at least one shared counter and whether or not the second program is permitted to access the at least one shared counter;
a program verification unit operable to verify integrity of the first program and verify integrity of the second program;
an access management unit operable to, when the verification of at least one of the integrity of the first program and the integrity of the second program fails, update the access permission information such that the access permission information shows that the at least one of the first program and the second program for which the verification of integrity failed is prohibited from accessing the at least one shared counter; and
a counter control unit operable to prevent, from accessing the at least one shared counter, the at least one of the first program and the second program shown as being prohibited from accessing the at least one shared counter in the access permission information.
